(19) United States
(12) Patent Application Publication
(10) Pub. No.: US 2026/0254657 A1
(43) Pub. Date: Aug. 27, 2026

(54) Behavioral-Economy Engine (BEI) Signature Protocol

(71) Applicant: FURONG BEI, SAN GABRIEL, CA (US)

(72) Inventor: FURONG BEI, SAN GABRIEL, CA (US)

(21) Appl. No.: 19/177,587

(22) Filed: Apr. 13, 2025

(51) Int. Cl. H04L 9/32

(52) U.S. Cl. CPC H04L 9/3247; H04L 9/3218; H04L 9/3231; H04L 9/3239; H04L 9/3271

(57) ABSTRACT

A BEI Signature Artifact is generated by a behavior-bound cryptographic signature state machine for sovereign identity anchors. A client device captures biometric, geolocation, temporal, device, domain, liveness, anti-deepfake, and behavioral inputs while retaining raw sensitive data locally and producing privacy-preserving proofs or commitments. A canonical behavioral payload includes an identity-anchor reference, BEI identity reference, domain basepoint or hash, nonce, validity window, device salt, behavior category, evidence commitment, policy version, lifecycle status, and expiration parameter. A server-side signature authority verifies liveness, proximity, privacy proof, canonical encoding, anti-replay state, and identity-domain consistency before issuing the artifact. A lifecycle registry and tamper-evident audit log maintain issued, active, challenged, suspended, recertified, revoked, and audit-commitment states, thereby enabling verifier-gated BEIMINT, BEINFT, BEIWALLET, BEIProof, BEISIGN, domain-token, real-world-asset, carbon-credit, access-control, clearing, rollback, and time-currency operations.

### CROSS-REFERENCE TO RELATED APPLICATIONS

This application relates to behavior-bound cryptographic signatures, Behavioral Economics Identity (BEI) identity anchors, verifier-gated token authority, minting eligibility, wallet authorization, non-fungible token certification, domain-token routing, and audit evidence for downstream transaction, clearing, and rollback workflows.

The disclosure may be used with, or implemented independently from, related BEI identity, BEISIGN transaction, BEIProof, BEIMINT, BEIWALLET, BEINFT, BEIFR2, BEICX, BEITREASURY, ATMS, and BEIECO systems. Any example endpoint, domain, product name, or ecosystem term is illustrative and non-limiting, and no claim requires a particular domain name unless expressly recited.

### FIELD OF THE INVENTION

The disclosure relates to cryptographic identity, privacy-preserving authentication, digital signatures, verifier registries, token metadata, lifecycle-controlled credentials, anti-replay state machines, and tamper-evident audit logging.

More particularly, the disclosure relates to systems, methods, and computer-readable media for generating, validating, recertifying, suspending, and verifying behavior-bound cryptographic signature artifacts that bind a human, device, behavior event, temporal window, domain context, and identity-anchor token while preserving privacy and supporting downstream minting, wallet, NFT, access-control, domain-token, clearing, and rollback workflows.

### BACKGROUND

Conventional private-key signatures prove control of a key but do not by themselves prove that a person was physically present, behaviorally active, within a permitted time window, within a permitted domain context, or still eligible under a token lifecycle state when the signature is used.

Conventional biometric authentication can establish a local match but often exposes sensitive raw biometrics, does not create a portable cryptographic artifact for downstream verifiers, and may not preserve a deterministic evidence trail connecting the biometric event to a token, domain, minting request, clearing request, or audit receipt.

Conventional wallet signing in blockchain systems frequently signs a transaction payload using a private key, but the signed payload may be disconnected from liveness, location, device consistency, domain identity, lifecycle recertification, and privacy-preserving proof requirements. A stolen private key or cloned session may therefore appear valid to a downstream contract or clearing endpoint.

Conventional FIDO, WebAuthn, passkey, DID, verifiable credential, and KYC systems provide useful identity or credential primitives, but they generally do not require a single behavior-bound state machine that canonicalizes multimodal behavior data, consumes nonces, validates domain consistency, binds an identity-anchor token, writes lifecycle status, and produces a verifier-gated signature artifact for token authority.

Conventional non-fungible token metadata can include arbitrary attributes, but the metadata may not contain a BEI Signature Artifact, a lifecycle status pointer, an audit-log commitment, and a verifier-registry endpoint sufficient for independent validation without raw personal data.

Conventional audit logs preserve events after execution, but often do not act as preconditions for minting, wallet authorization, domain-token routing, NFT certification, access control, clearing eligibility, or rollback evidence. A technical gap exists between a signature operation and the downstream authority that relies on it.

Artificial-intelligence-generated faces, voices, gestures, and device-session simulations increase the risk that static biometric checks and ordinary key signatures will be bypassed by deepfake or synthetic-presence attacks. A behavior-bound signature system should therefore support unpredictable challenges, sensor fusion, and deepfake confidence inputs as gate conditions.

Real-world asset tokenization, carbon-credit measurement, healthcare events, education credentials, field inspections, and time-currency or behavior-currency workflows require proof that an authorized human, device, or source actually performed a behavior at a physical or logical context before a digital asset or credential is issued. Existing systems do not uniformly bind such behavior to identity, domain, lifecycle, and audit states.

There is a need for a technical system that generates a portable, privacy-preserving, BEI Signature Artifact only after liveness, proximity, domain, time, device, anti-replay, identity-anchor, and lifecycle conditions are satisfied, and that allows a downstream verifier to validate the artifact without receiving raw biometrics or private operator logs.

### SUMMARY OF THE INVENTION

Disclosed are server-side behavior-bound cryptographic signature authority systems, client-device methods, and verifier-side computer-readable media that create and enforce a BEI Signature Artifact. The artifact operates as a technical gate for token issuance, minting eligibility, wallet authorization, NFT certification, domain-token routing, access control, clearing compliance, or rollback evidence.

In one aspect, a server-side signature authority receives a canonical behavioral payload or commitment package from a client device or authorized source. The payload includes an identity-anchor reference, domain-context data, temporal marker data, device-context data, behavioral-context data, a nonce or uniqueness value, and commitments or proofs relating to biometric, location, liveness, or presence inputs.

The server-side authority verifies a privacy-preserving proof, validates deterministic canonicalization, evaluates a domain hash and validity window, consumes or rejects a nonce through an anti-replay state machine, validates identity-and-domain binding, and generates a BEI Signature Artifact only when each gate returns an accept state.

In another aspect, the client device captures multimodal inputs and constructs the canonical behavioral payload. The client device may retain raw biometric or exact location data locally and transmit only commitments, selective-disclosure credentials, or zero-knowledge proofs sufficient to prove presence, consistency, and policy satisfaction.

In another aspect, a verifier, minting endpoint, wallet, access-control endpoint, NFT certification endpoint, domain-token endpoint, standards gateway, clearing endpoint, or external validator receives the BEI Signature Artifact and checks public-key signature validity, domain hash, nonce state, validity window, lifecycle status, and audit-log commitment before allowing an operation.

The invention provides a concrete technical improvement over ordinary private-key signing, ordinary biometric login, ordinary wallet signing, ordinary KYC, ordinary NFT metadata, and ordinary audit logging because the signature artifact is created and accepted only through an integrated state machine having canonical payload construction, privacy-preserving proof verification, anti-replay state management, lifecycle registry control, and tamper-evident audit commitment.

The system is chain-neutral, cryptographic-algorithm-neutral, and messaging-rail-neutral. Examples include, without limitation, ECDSA, EdDSA, threshold signatures, hardware-secured signing, post-quantum signatures, SHA-256, SHA-3, BLAKE2, BLAKE3, smart-contract verifiers, off-chain verifiers, standards-gateway verifiers, append-only logs, Merkle logs, distributed ledgers, WORM storage, and permissioned ledgers.

### BRIEF DESCRIPTION OF THE DRAWINGS

FIG. 1 illustrates a server-side behavior-bound signature authority system corresponding to the system architecture of claim 1.

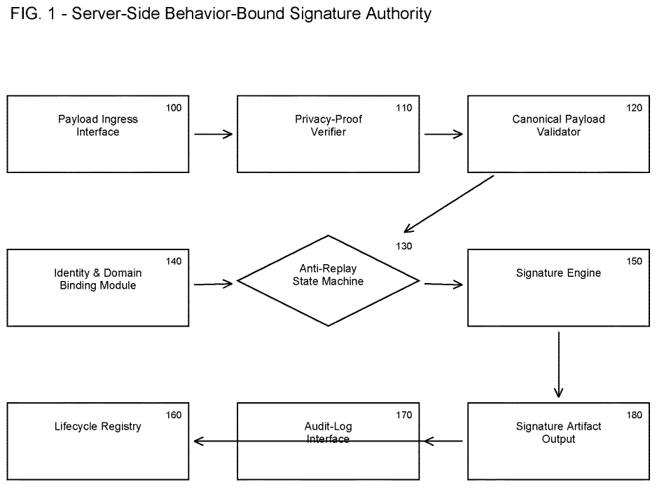

FIG. 2 illustrates a client-device capture, proof generation, and canonical payload construction method corresponding to the client-device method of claim 9.

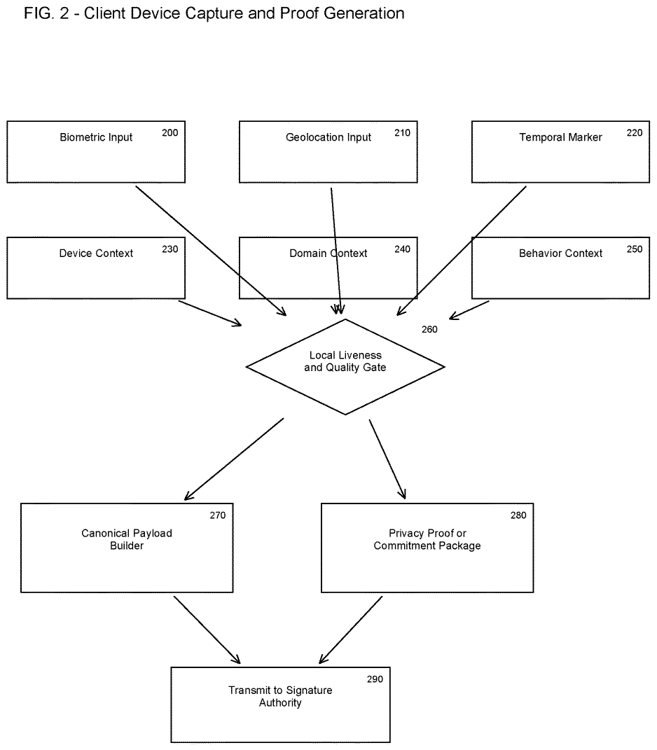

FIG. 3 illustrates a canonical behavioral payload data structure and related field commitments.

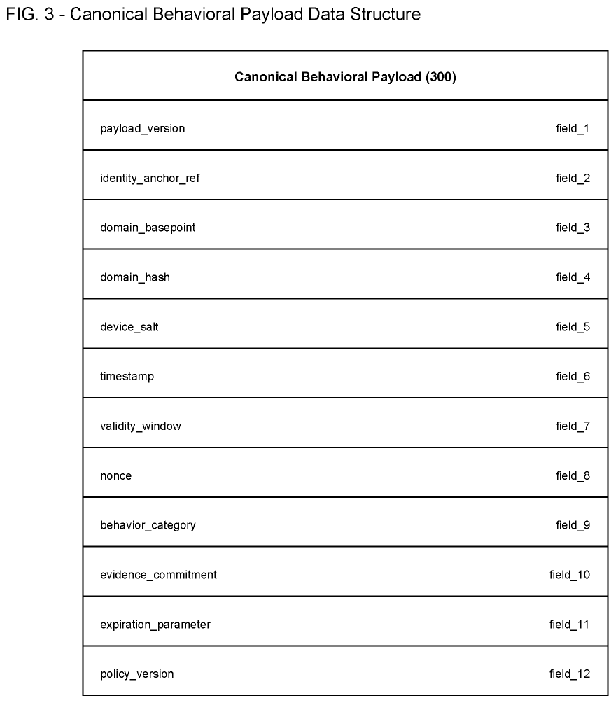

FIG. 4 illustrates an anti-replay and gate-state machine including accept, reject, degrade, challenge, signed, bound, expired, suspended, recertified, and revoked states.

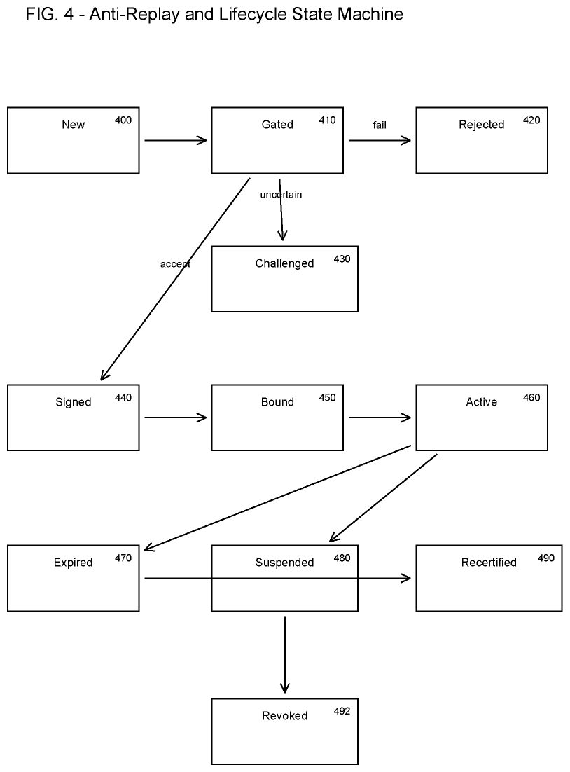

FIG. 5 illustrates liveness, deepfake-defense, and sensor-fusion inputs for privacy-preserving behavior-presence proof generation.

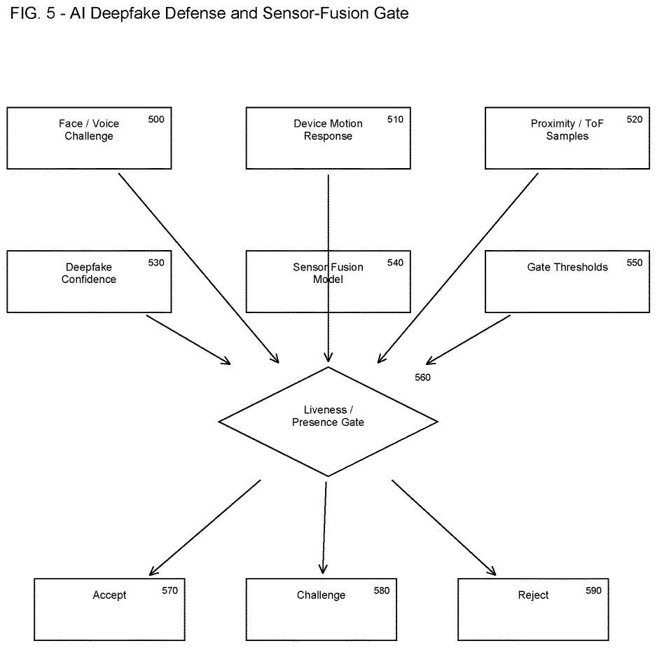

FIG. 6 illustrates a BEI Signature Artifact lifecycle registry and audit-log commitment chain.

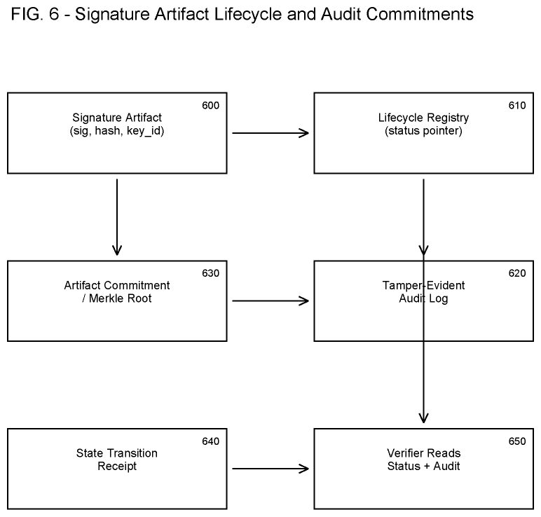

FIG. 7 illustrates verifier, minting, wallet, NFT, domain-token, access-control, and clearing endpoints that rely on signature lifecycle status before allowing operations.

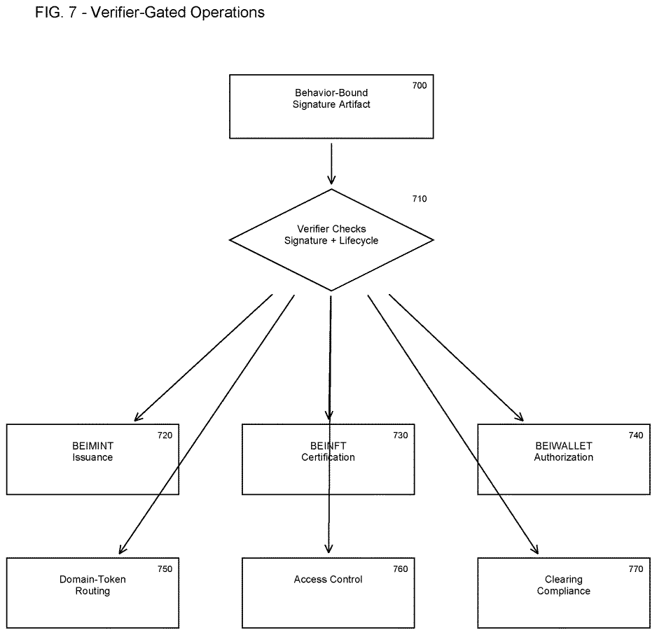

FIG. 8 illustrates a privacy-preserving zero-knowledge or selective-disclosure verification flow in which raw biometric data remains local.

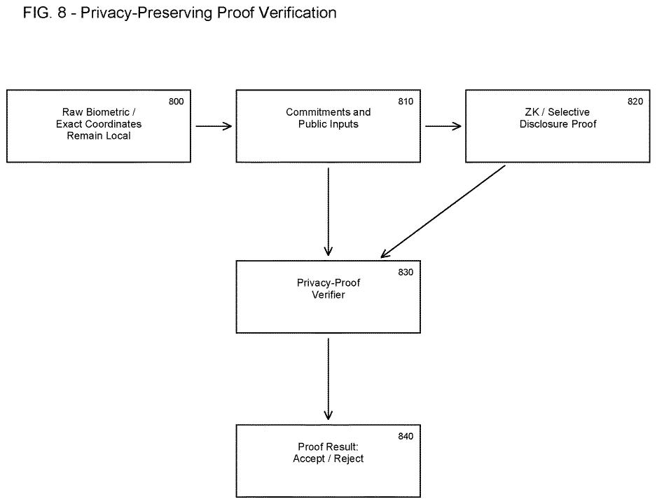

FIG. 9 illustrates real-world-asset and site-observation certification using BEI Signature Artifacts.

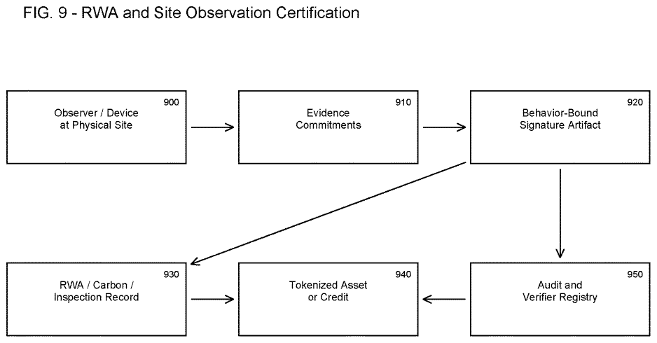

FIG. 10 illustrates non-limiting BEI endpoint-domain deployments for identity, proof, signature, minting, ecosystem, ATMS, rollback, and clawback functions.

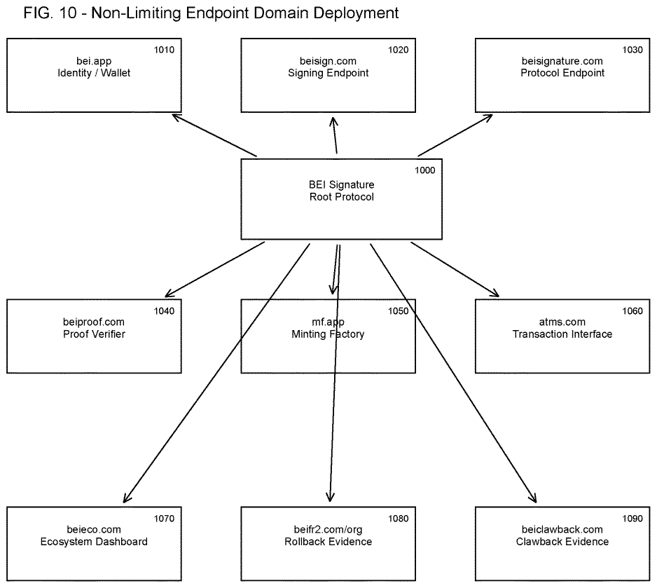

FIG. 11 illustrates a multi-entity deployment in which client, server, verifier, and audit endpoints can each practice a single-actor claim subset.

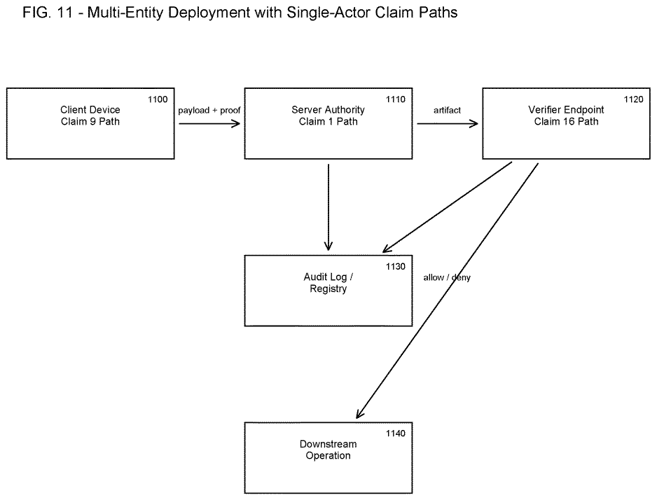

FIG. 12 illustrates a claim-to-module support map showing how each drawing supports claim elements.

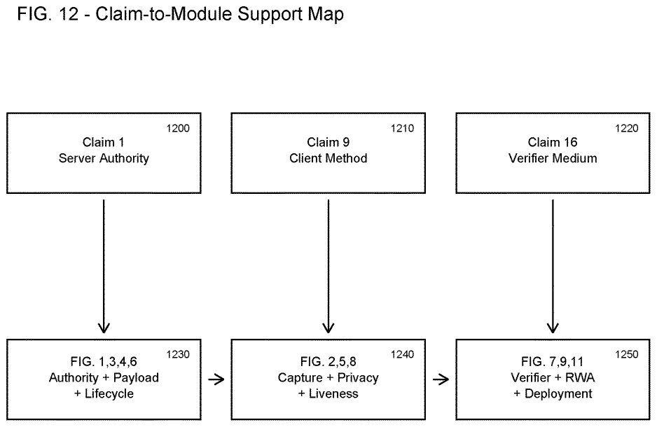

### DEFINITIONS

Behavioral Economics Identity or BEI: As used herein, the term “Behavioral Economics Identity” or “BEI” means a computer-implemented identity representation associated with a person, device, organization, agent, domain, account, token, or other subject, wherein the identity representation is configured to bind one or more behavior records, time references, domain contexts, credential references, lifecycle states, cryptographic commitments, or verifier decisions to the subject. A BEI may be implemented using decentralized identifiers, verifiable credentials, account-bound identifiers, domain-based identifiers, token-bound identifiers, public-key identifiers, or equivalent machine-verifiable identity structures.

Civilizational-Economy Identity: As used herein, the term “Civilizational-Economy Identity” means a BEI identity representation configured for use in a multi-domain, multi-institution, or multi-jurisdiction value infrastructure in which verified behavior, time references, contribution records, identity data, domain contexts, token authority, or audit evidence may be used to support downstream digital operations. The term describes technical identity infrastructure and does not require adoption of any political, economic, monetary, or social theory.

BEI Protocol: As used herein, the term “BEI Protocol” means a set of computer-implemented rules, data structures, verification procedures, lifecycle states, and interface requirements for binding Behavioral Economics Identity, behavior records, identity-anchor tokens, domain contexts, cryptographic signatures, verifier decisions, audit commitments, and downstream operation authority. A BEI Protocol may be implemented as software, firmware, server-side logic, client-side logic, verifier logic, smart-contract logic, application programming interfaces, domain endpoint records, or combinations thereof.

BEI Standard or BEI Signature Standard: As used herein, the term “BEI Standard” or “BEI Signature Standard” means an implementation profile or interoperability specification defining one or more required or optional fields, payload formats, signature verification procedures, lifecycle-state codes, verifier-gated authority rules, audit-commitment formats, domain-context mappings, or endpoint interfaces for generating, verifying, recertifying, suspending, or revoking BEI Signatures or BEI Signature Artifacts.

BEI Signature: As used herein, the term “BEI Signature” means a behavior-bound cryptographic signature generated or verified according to a BEI Protocol, wherein the signature is based on a canonical behavioral payload including at least one behavioral, temporal, device, domain, identity-anchor, lifecycle, or audit-related field. A BEI Signature is not limited to a handwritten, electronic, or conventional digital signature and may function as a machine-verifiable authority object for identity verification, token issuance, wallet authorization, NFT certification, domain-token routing, minting eligibility, access control, clearing compliance, rollback evidence, or other verifier-gated operations.

BEI Signature Artifact: As used herein, the term “BEI Signature Artifact” means a cryptographically verifiable, behavior-bound signature object generated by the disclosed cryptographic signature state machine and bound to a sovereign identity anchor, BEI identity reference, domain context, validity window, lifecycle state, audit commitment, and verifier-gated authority. The BEI Signature Artifact may include or reference a canonical payload hash, signature value, public-key identifier, nonce, device salt, domain hash, evidence commitment, privacy-preserving proof reference, lifecycle status, verifier decision, or tamper-evident audit-log commitment.

Sovereign Identity Anchor: As used herein, the term “Sovereign Identity Anchor” means a machine-verifiable identity anchor, including a token, credential, account-bound record, domain-bound record, decentralized identifier record, non-transferable token, selectively transferable token, token-bound identifier, or equivalent lifecycle-managed identity object that binds a BEI identity to cryptographic verification data, lifecycle status, domain context, or verifier authority. The term is not limited to any cryptocurrency, payment token, investment token, blockchain token standard, ledger, wallet, credential format, or jurisdictional identity system. In some embodiments, a Sovereign Identity Anchor may be implemented as a sovereign identity anchor token.

Domain Context and Domain Hash: As used herein, the term “Domain Context” means a domain name, subdomain, domain-derived identifier, endpoint basepoint, namespace record, service endpoint, domain-token reference, or equivalent routing context associated with a BEI identity, signature operation, verifier decision, or downstream operation. As used herein, the term “Domain Hash” means a cryptographic commitment, hash value, digest, or encoded representation derived from a domain context and included in, or referenced by, a canonical behavioral payload, BEI Signature, BEI Signature Artifact, audit log, lifecycle record, or verifier decision.

Verifier-Gated Authority: As used herein, the term “Verifier-Gated Authority” means an operation permission, denial, conditional allowance, challenge, suspension, recertification, revocation, rollback-evidence decision, or lifecycle-state transition made by a verifier based on a BEI Signature Artifact, lifecycle status, domain hash, validity window, anti-replay state, identity-anchor reference, privacy-preserving proof, and audit-log commitment.

International Standard Compatibility: As used herein, the term “International Standard Compatibility” means that an embodiment may interoperate with, map to, extend, or be transported through one or more existing or future identity, credential, cryptographic, financial messaging, domain-name, cybersecurity, or audit standards, including without limitation W3C decentralized identifiers, W3C verifiable credentials, FIDO/WebAuthn, ISO 20022 financial messages, X.509 public-key infrastructure, DNSSEC, DANE, TLS, OAuth, OpenID Connect, zero-knowledge proof systems, distributed-ledger standards, or equivalent interoperability frameworks. Such compatibility is optional and does not limit the BEI Protocol to any particular external standard.

Behavior-bound signature artifact: The term “behavior-bound signature artifact” may refer to a BEI Signature Artifact or to an equivalent cryptographic object produced after a canonical behavioral payload has passed liveness, privacy-proof, domain, time-window, anti-replay, identity-anchor, and lifecycle gates. The term includes portable evidence objects that can be verified without disclosing raw biometric templates or exact location coordinates.

Canonical behavioral payload: A deterministic data object or byte sequence containing fields in a defined order so that a verifier or authority computes the same payload hash from the same semantic inputs. The canonical behavioral payload may be encoded using JSON canonicalization, CBOR canonicalization, protocol buffers, a fixed binary layout, or an equivalent deterministic encoding procedure.

Privacy-preserving proof: A zero-knowledge proof, zk-SNARK, zk-STARK, selective-disclosure credential, verifiable credential presentation, trusted-execution-environment attestation, multi-party attestation, threshold attestation, or equivalent proof that demonstrates a required condition without exposing one or more raw sensitive inputs.

Liveness gate: A module or state-machine condition that determines whether a captured input is likely produced by a present human or authorized physical source rather than by a replay, static image, synthetic voice, deepfake, sensor spoof, or stale session artifact.

Anti-replay state machine: A state machine that tracks nonces, counters, prior signature hashes, validity windows, consumed uniqueness values, device consistency, domain consistency, lifecycle status, and related conditions to prevent a previously valid input or signature artifact from being reused outside its intended context.

Lifecycle registry: A registry, log, database, smart contract, append-only record, or equivalent state store that records issued, bound, active, expired, challenged, suspended, recertified, revoked, or audit-committed states for a BEI Signature Artifact or identity-anchor token.

Verifier registry: A registry that publishes public verification keys, lifecycle-status endpoints, policy parameters, supported proof schemes, domain endpoints, or other data used by a verifier to determine whether a BEI Signature Artifact remains valid for a downstream operation.

Tamper-evident audit log: An append-only log, Merkle tree, distributed ledger, permissioned ledger, WORM storage, or other integrity-preserving data structure that records commitments to payloads, signatures, lifecycle states, verifier decisions, or downstream operation receipts.

Civilizational-economy contribution event: A non-limiting behavior event in a large-scale identity, time, work, health, education, environmental, care, inspection, delivery, or contribution infrastructure that may be represented by a BEI identity and verified using a BEI Signature Artifact as a technical gate for downstream digital operations.

### MODULE INPUTS AND OUTPUTS

Each module is described by explicit inputs, outputs, and state effects. Implementations may combine modules within one computing environment or distribute them across a client device, signature authority, verifier, registry, audit log, smart contract, standards gateway, or clearing endpoint.

### CANONICAL PAYLOAD FIELD TABLE

A canonical behavioral payload may be represented as a deterministic byte sequence, JSON canonicalization, CBOR canonicalization, protocol buffer canonical form, typed-data encoding, or equivalent canonicalization. The following table is non-limiting.

### STATE TRANSITION TABLE

### ANTI-REPLAY PSEUDOCODE

function validate_replay(payload): parse payload_version, identity_anchor_ref, domain_hash, nonce, validity_window, device_salt, prior_signature_hash; if current_time not in validity_window: return REJECT_STALE_WINDOW; if nonce in consumed_nonce_set[identity_anchor_ref, domain_hash]: return REJECT_REUSED_NONCE; if device_salt inconsistent with lifecycle_registry[identity_anchor_ref]: return CHALLENGE_DEVICE; if domain_hash inconsistent with registered endpoint: return REJECT_DOMAIN; if prior_signature_hash conflicts with active lifecycle state: return CHALLENGE_PRIOR_STATE; mark nonce as pending; return ACCEPT_REPLAY_CHECK. f

unction issue_signature(payload): if privacy_proof!=ACCEPT: return REJECT_PRIVACY_PROOF; if canonical_validator(payload)!=ACCEPT: return REJECT_CANONICAL; if validate_replay(payload)!=ACCEPT_REPLAY_CHECK: return rejection_code; hash=H(canonical_bytes(payload)); sig=SIGN(authority_key, hash); artifact=assemble(sig, hash, key_id, lifecycle_pointer, expiration_parameter); commit artifact to audit_log; mark nonce consumed; return artifact.

function verify_artifact(artifact, payload_commitment): retrieve public key and lifecycle status; verify signature over payload hash; verify audit-log commitment; verify domain hash, nonce status, and validity window; if lifecycle status in expired, challenged, suspended, revoked, inconsistent, or not found: deny or request recertification; else allow operation subject to operation-specific policy.

### DETAILED DESCRIPTION OF SERVER-SIDE SIGNATURE AUTHORITY

A server-side behavior-bound signature authority is a computing system that may be operated by an identity provider, wallet provider, BEI service provider, domain-token service, minting factory, NFT certification service, access-control service, financial gateway, clearing pre-check service, or independent verifier. The authority may be implemented as a cloud service, edge server, on-premises appliance, permissioned consortium node, smart-contract-assisted service, or hybrid deployment.

The payload-ingress interface receives a canonical behavioral payload, a commitment to the payload, or a proof package whose public inputs correspond to the payload fields. In privacy-preserving embodiments, raw face, voice, fingerprint, gait, exact location, or detailed movement data remains on a user device or trusted local processor, while the authority receives only commitments and proof outputs.

The privacy-proof verifier determines whether the evidence package demonstrates liveness, proximity, input consistency, authorized region, enrolled device consistency, or other policy criteria. The verifier need not learn the raw biometric template or precise coordinates. This separation makes the system suitable for privacy-preserving compliance and for high-value authorization environments in which raw personal data should not traverse transaction rails.

The canonical-payload validator prevents semantic substitution attacks. For example, a payload field order, domain string normalization, Unicode normalization, timestamp encoding, endpoint basepoint format, behavior category code, nonce length, and hash input can be fixed by a payload_version. A verifier can recompute the same payload hash and detect even minor field changes.

The identity-and-domain binding module prevents a valid signature artifact from one identity or domain context from being replayed in another context. The module compares the identity-anchor reference, domain hash, endpoint registry, and lifecycle status. If a wallet credential, minting request, NFT record, access credential, domain-token route, or clearing pre-check refers to a different domain hash, the verifier denies the operation or requests recertification.

The cryptographic signature engine is deliberately algorithm-neutral. A system may use ECDSA secp256k1 and SHA-256 in a blockchain-oriented embodiment, EdDSA in a high-speed wallet embodiment, threshold or hardware-secured signing in an institutional embodiment, and post-quantum signatures in a long-term civilizational-economy infrastructure embodiment. Claims are not limited to a single cryptographic curve or chain.

The lifecycle registry makes the signature artifact more than an ordinary signature. A downstream verifier checks whether the artifact is active, expired, challenged, suspended, recertified, or revoked. A stolen or stale artifact therefore cannot remain a permanent authority merely because the original signature bytes verify cryptographically.

The audit-log interface records commitments to signature artifacts and state-transition receipts. The audit data may include an artifact identifier, payload hash, domain hash, identity-anchor reference, public-key identifier, lifecycle state, time of transition, and transition reason. The audit log can be implemented without exposing raw biometric data.

### DETAILED DESCRIPTION OF CLIENT-DEVICE CAPTURE AND PRIVACY PROOF

A client device may include a mobile phone, wearable, laptop, vehicle system, point-of-interaction terminal, medical sensor, field-inspection device, educational terminal, industrial device, wallet, browser, passkey authenticator, or other device capable of collecting or receiving evidence of behavior presence.

The client device captures multimodal inputs. Examples include facial motion, voice response, fingerprint contact, gait, device inertial measurement, GPS, Wi-Fi positioning, cellular triangulation, BLE distance-bounding, NFC nonce, time-of-flight samples, proximity beacon, camera image, sensor timestamp, device secure-element measurement, and local user interaction.

A local liveness and quality gate processes the input data. The gate may run computer vision, voice challenge, motion correlation, device proximity, unpredictable prompt-response, sensor-fusion, or deepfake-detection logic. The gate result may be accept, reject, degrade, or challenge, and may include a confidence bucket or failure code.

The client device constructs a canonical behavioral payload from public fields and commitments. Raw biometric templates or exact coordinates can remain locally stored, encrypted, or discarded after proof generation. The transmitted payload may include a commitment to the biometric match, a commitment to a location region, and a proof that thresholds were satisfied.

A zero-knowledge or selective-disclosure proof may prove that a live person responded to an unpredictable prompt, that a device was within an authorized region, that the behavior occurred inside a validity window, or that a device salt corresponds to an enrolled device. The proof allows downstream validation without mass disclosure of sensitive evidence.

Upon receiving the BEI Signature Artifact, the client device binds the artifact to a wallet credential, token metadata record, minting request, NFT certificate, access credential, domain-token route, BEIProof verification record, or clearing-eligibility request. The binding may include the artifact, artifact hash, lifecycle pointer, and verifier-registry endpoint.

### DETAILED DESCRIPTION OF VERIFIER-GATED OPERATIONS

A verifier endpoint may be operated by a wallet, minting factory, NFT service, domain-token service, standards gateway, access-control service, real-world-asset registry, carbon-credit registry, education credential platform, health event system, clearing gateway, or external validator. The verifier receives a BEI Signature Artifact and a payload commitment or canonical payload.

The verifier does not rely solely on signature bytes. Instead, the verifier retrieves public-key material, verifies the payload hash, checks domain hash and identity-anchor consistency, evaluates nonce or uniqueness state, validates the validity window, retrieves lifecycle status, and confirms an audit-log commitment.

If the lifecycle status is expired, challenged, suspended, revoked, inconsistent, or not found, the verifier denies the operation or requests step-up recertification. The operation can be a mint, NFT certification, wallet authorization, access grant, domain-token route, clearing pre-check, rollback evidence record, or RWA observation certification.

Verifier-gated operation creates a technical bottleneck that is useful without being limited to any one commercial brand. For example, a civilizational-economy identity infrastructure can require BEI Signature Artifacts before time-currency issuance, behavior-credit issuance, care-work certification, education-credit recording, environmental contribution recording, or public-service contribution indexing.

### EXAMINER-FACING TECHNICAL DISTINCTIONS

### MULTI-ENTITY AND SINGLE-ACTOR DEPLOYMENT SUPPORT

A high-value deployment can distribute functions across a client device, server-side signature authority, verifier registry, audit log, smart contract, standards gateway, or clearing endpoint. To improve enforceability and implementation flexibility, the disclosure supports single-actor claim subsets.

A server-side operator can practice the server-side authority by receiving commitments or canonical payloads, verifying privacy proofs, applying anti-replay and lifecycle logic, generating signature artifacts, and writing audit commitments without manufacturing the client device.

A client-device operator can practice the client method by capturing multimodal inputs, generating local commitments or zero-knowledge proofs, constructing canonical payloads, and binding received signature artifacts to wallet or token records without operating the server-side authority.

A verifier, wallet, minting, NFT, access-control, domain-token, or clearing endpoint can practice verifier-gated validation by receiving a signature artifact, checking lifecycle status, domain hash, validity window, and audit commitments, and allowing or denying a downstream operation without possessing raw biometric data.

These single-actor embodiments reduce dependency on a divided-infringement theory and support licensing to device makers, wallet providers, cloud identity providers, NFT platforms, minting factories, clearing gateways, and compliance verifiers under distinct field-of-use licenses.

### ZERO-KNOWLEDGE AND PRIVACY-PRESERVING EMBODIMENTS

In a privacy-preserving embodiment, a user device proves in zero knowledge that a biometric match score exceeds a threshold, a location commitment is within an authorized region, a liveness challenge was completed, a device salt corresponds to an enrolled device, and the event occurred inside a validity window. The signature authority or verifier learns only proof validity and public commitments.

A zk-SNARK, zk-STARK, Bulletproof-style proof, selective-disclosure credential, verifiable credential presentation, TEE quote, secure element attestation, or threshold witness proof can be used. The proof system is not limited to one proving scheme.

The proof can include public inputs such as payload_version, domain_hash, nonce, validity_window, policy_version, and evidence_commitment. Private witnesses can include raw biometric features, exact coordinates, sensor traces, device-secret material, or challenge responses. The resulting proof enables privacy-preserving compliance and reduces data exposure.

### AI AND DEEPFAKE-DEFENSE EMBODIMENTS

In an AI-era embodiment, the liveness gate includes an artificial-intelligence-generated impersonation detector. The detector may analyze face movement, voice spectral features, challenge response timing, lip-synchronization, sensor motion correlation, inertial response, light-field consistency, depth data, device proximity, keystroke cadence, or multimodal coherence.

The detector can output confidence buckets such as low risk, medium risk, high risk, and synthetic-presence suspected. A high-risk bucket may force challenge, degrade, or suspend states rather than immediate signature issuance.

An unpredictable real-time interaction may be bound into the payload. Examples include speaking a random phrase, rotating a device, moving within a bounded range, touching a secure element, scanning a near-field tag, providing a gait sample, or presenting a dynamic QR or beacon. The response commitment can be included in the canonical payload.

### REAL-WORLD ASSET AND CIVILIZATIONAL-ECONOMY EMBODIMENTS

For real-world asset embodiments, the BEI Signature Artifact can certify that an authorized human, device, or source performed an observation, inspection, delivery, measurement, care event, education event, health event, environmental event, infrastructure event, or public-service contribution in a defined time and domain context.

In a carbon-credit embodiment, an auditor at a forest, farm, facility, vehicle site, or sensor station generates a BEI Signature Artifact that binds location, time, device, identity anchor, and evidence commitments before a carbon measurement or environmental credit is tokenized.

In an education embodiment, a learning terminal, institution, or instructor verifies that a learner completed a time-bounded task, examination, credential exercise, or attendance event without disclosing unnecessary personal data.

In a health or care embodiment, a patient, caregiver, clinician, device, or institution can create a BEI Signature Artifact for a care event, medication adherence event, preventive health behavior, or service record, subject to privacy-preserving proof and lifecycle controls.

In a civilizational-economy infrastructure embodiment, BEI Signature Artifacts become machine-verifiable gates for value generation, indexing, wallet authority, and ecosystem operations. The technical requirement is not a slogan: each eligible event must pass identity-anchor, domain, validity-window, privacy-proof, anti-replay, lifecycle, and audit-commitment checks before downstream value is recognized.

### NON-LIMITING IMPLEMENTATION ENDPOINTS

Non-limiting implementation endpoints may include identity, signature, proof, minting, wallet, transaction, rollback, clawback, ecosystem, and ATMS endpoints. Example domain names may include beisignature.com, beisign.com, beiproof.com, bei.app, beieco.com, mf.app, atms.com, beifr2.com, beifr2.org, and beiclawback.com, or equivalent endpoints.

The domain names are examples of endpoint basepoints and do not limit the claims. A claim element reciting domain-context data, domain hash, endpoint, basepoint, namespace, or route can be implemented using conventional DNS, DNSSEC, DID documents, HTTPS records, TXT records, signed endpoint records, service registries, smart-contract registries, or equivalent routing mechanisms.

In an implementation, bei. app can operate as a user identity and wallet entrance, beisign. com can operate as a signing service entrance, beisignature. com can publish protocol documentation or registry data, beiproof. com can operate as a proof-verification endpoint, mf. app can operate as a minting factory endpoint, atms. com can operate as a transaction or financial interface, beieco. com can operate as an ecosystem dashboard, and beifr2.com, beifr2.org, or beiclawback. com can operate as rollback or clawback evidence endpoints.

### OPERATIONAL EXAMPLES

Example 1—BEI identity issuance. A user enrolls an identity-anchor token. The user device captures liveness, device, time, and domain-context data, constructs a payload, and obtains a BEI Signature Artifact. The identity service issues or updates an identity record only if the verifier confirms lifecycle status and audit commitment.

Example 2—BEIMINT eligibility. A minting factory receives a request for behavior-based value issuance. The minting factory does not accept the request unless the signature artifact verifies, the lifecycle status is active, the validity window has not expired, the domain hash matches, and the audit-log commitment exists.

Example 3—BEINFT certification. An NFT platform certifies a digital object, real-world observation, creative contribution, or credential record by attaching a BEI Signature Artifact and verifier-registry endpoint to token metadata. The platform can later suspend or recertify the metadata if lifecycle status changes.

Example 4—Wallet high-risk authorization. A wallet requires a BEI Signature Artifact before high-risk transfers, account recovery, key rotation, delegated AI-agent authorization, or cross-domain actions. A stolen key alone is insufficient because the verifier also checks liveness, nonce, domain, and lifecycle state.

Example 5—BEISIGN transaction entry. A transaction rail receives a signature artifact generated under this disclosure and uses it as a precondition for entering an attest-consent-transact state machine, issuing a secure execution token, creating a clearing ticket, or preserving rollback evidence.

Example 6—RWA site certification. A field auditor signs an inspection event for a bridge, farm, forest, clinic, warehouse, vehicle, sensor, or energy site. The artifact binds the observation to time, location, device, identity anchor, domain, and audit commitment before any tokenized asset, carbon credit, or certification claim is recognized.

Example 7—Civilizational-economy contribution. A care, learning, health, public service, green, or community contribution event is recognized by an ecosystem only after a verifier confirms that a BEI Signature Artifact is active and satisfies the operation-specific policy.

### TECHNICAL ADVANTAGES

The system reduces replay risk by requiring nonce consumption, validity-window checking, domain consistency, device consistency, prior-signature-state checking, and lifecycle status before signature issuance or operation approval.

The system reduces privacy exposure by allowing raw biometric data and exact coordinates to remain on the client device while transmitting commitments, selective disclosures, or zero-knowledge proof outputs.

The system reduces key-theft risk because possession of a private key or wallet session does not alone satisfy behavior-bound signature requirements. Liveness, device, domain, and lifecycle states must also pass.

The system improves downstream interoperability because the same artifact can be checked by wallet, minting, NFT, domain-token, access-control, RWA, clearing, and external-verifier endpoints without requiring each endpoint to recreate raw data collection.

The system improves auditability because each artifact and state transition can be committed to tamper-evident storage while preserving user privacy.

The system improves long-term technical resilience because the independent architecture is not limited to a particular cryptographic curve, blockchain, token standard, message rail, registry, or commercial domain.

### CLAIM SUPPORT MATRIX

### ALTERNATIVE EMBODIMENTS

The identity-anchor token can be transferable, non-transferable, account-bound, device-bound, DID-linked, verifiable-credential-linked, institution-linked, or lifecycle-bound. The system can enforce stricter non-transferability when used for high-risk identity or minting operations.

The domain-context data can be a human-readable domain, subdomain, URI, DID service endpoint, smart-contract address, registry key, API endpoint, basepoint, or namespace entry. The domain hash can be derived from any normalized representation selected by the payload_version.

The audit-log commitment can be written before signature issuance, after signature issuance, after downstream operation approval, or at each lifecycle state transition. A multi-header receipt can be used in some embodiments, but no claim requires a particular receipt branding or governance body unless expressly recited.

The verifier may operate on-chain, off-chain, in a standards gateway, inside a wallet, inside a clearing gateway, inside an enterprise server, or inside a regulated institution. The same artifact format can be mapped across heterogeneous rails.

The system may be deployed as a closed enterprise system, open registry, public-good infrastructure, regulated financial gateway, healthcare privacy system, education credential system, environmental measurement system, or civilizational-economy standard layer.

### INDUSTRIAL APPLICABILITY

The disclosed systems and methods are applicable to digital identity, wallet authorization, passkeys, decentralized identity, NFT certification, minting eligibility, domain-token routing, real-world asset observation, carbon-credit measurement, education credentialing, healthcare event proof, access control, AI-agent authorization, financial transaction pre-checks, clearing compliance, rollback evidence, and large-scale civilizational-economy value systems.

The invention can be implemented in software, firmware, hardware secure elements, trusted execution environments, smart contracts, cloud services, client devices, enterprise gateways, standards gateways, verifier registries, and tamper-evident audit-log systems.

Because the disclosed technology centers on canonical payloads, state machines, lifecycle registries, verifier-gated operations, and privacy-preserving proof validation, it can remain useful across cryptographic algorithm updates, blockchain changes, identity-standard changes, and messaging-rail changes.

### CLAIM-BY-CLAIM TECHNICAL SUPPORT

Claim 1 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 2 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 3 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 4 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 5 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 6 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 7 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 8 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 9 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 10 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 11 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 12 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 13 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 14 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 15 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 16 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 17 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 18 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 19 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

Claim 20 is supported by the described modules, data structures, state transitions, drawings, and examples. The claim element is implemented with defined inputs, defined outputs, and at least one state effect. The applicable modules receive a canonical payload, proof, lifecycle state, or artifact; process it using deterministic validation or state-machine logic; and output a signature artifact, rejection code, lifecycle status, audit commitment, or operation decision.

### ADDITIONAL NON-LIMITING IMPLEMENTATION DETAILS

Payload canonicalization: The canonicalization process can enforce field ordering, numeric representation, timestamp representation, string normalization, domain normalization, binary commitment encoding, and hash-input separators. A malformed payload or inconsistent encoding leads to rejection before signing.

Key management: Signing keys can be software keys, hardware secure module keys, threshold keys, multi-party computation keys, device-bound keys, institution-bound keys, post-quantum keys, or rotating keys. Public key identifiers allow verifiers to retrieve the correct verification material.

Verifier registry update: A verifier registry can publish supported proof schemes, accepted payload versions, active public keys, revoked public keys, domain endpoints, lifecycle registry endpoints, and audit-log endpoints. Verifiers can cache registry data but must respect expiration and versioning.

Lifecycle recertification: Recertification can generate a new artifact linked to a previous artifact hash. A recertified state can preserve a continuity chain while preventing stale or compromised artifacts from authorizing future operations.

Rollback evidence: When a downstream system disputes or reverses an operation, the behavior-bound artifact and state-transition receipts can provide evidence of what was validated, which domain was bound, and whether lifecycle status was active at the time of operation.

AI agent delegation: A human user can issue a BEI Signature Artifact that limits an AI agent to a validity window, domain, wallet, amount class, resource class, behavior class, or operation policy. A verifier denies AI-agent actions outside that scope.

Offline operation: A client or verifier may cache active policy and registry entries for low-latency or offline checks. A later synchronization can write audit commitments and reconcile lifecycle status; stale cache use can trigger challenge or conditional allow states.

Endpoint routing: A signed endpoint record can map a domain basepoint to identity, proof, signature, mint, wallet, audit, rollback, or clearing endpoints. The domain hash binds the artifact to the intended endpoint context.

Failure code portability: Failure codes can be represented as numeric codes, strings, enums, or policy-specific reason codes. Examples include stale_timestamp, reused_nonce, proof_invalid, liveness_low, deepfake_high, device_mismatch, domain_mismatch, lifecycle_suspended, registry_unavailable, and audit_commit_missing.

Data minimization: The invention can implement data minimization by storing raw personal data locally, discarding raw data after proof generation, encrypting raw data under user control, or storing only commitments and proof outputs in server-side records.

Civilizational scale: At civilizational scale, millions or billions of artifacts can be validated through hierarchical registries, sharded audit commitments, batched Merkle roots, or regional verifier endpoints. The technical architecture remains the same: artifact validity depends on proof, canonical payload, anti-replay, lifecycle, domain, and audit state.

Standards mapping: The artifact can be mapped into wallet metadata, NFT metadata, DID service endpoints, verifiable credentials, payment messages, clearing tickets, JSON APIs, CBOR objects, typed-data signatures, or smart-contract calldata while preserving the payload hash and lifecycle pointer.

### DETAILED EMBODIMENT VARIATIONS

Embodiment variation 1—identity issuance. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant identity issuance record and committed to a tamper-evident audit log. A downstream verifier denies the operation if the artifact is expired, challenged, suspended, revoked, or inconsistent with the requested domain or operation-specific policy.

Embodiment variation 2—wallet authorization. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant wallet authorization record and committed to a tamper-evident audit log. A downstream verifier denies the operation if the artifact is expired, challenged, suspended, revoked, or inconsistent with the requested domain or operation-specific policy.

Embodiment variation 3—minting eligibility. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant minting eligibility record and committed to a tamper-evident audit log. A downstream verifier denies the operation if the artifact is expired, challenged, suspended, revoked, or inconsistent with the requested domain or operation-specific policy.

Embodiment variation 4—NFT certification. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant NFT certification record and committed to a tamper-evident audit log. A downstream verifier denies the operation if the artifact is expired, challenged, suspended, revoked, or inconsistent with the requested domain or operation-specific policy.

Embodiment variation 5—domain-token routing. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant domain-token routing record and committed to a tamper-evident audit log. A downstream verifier denies the operation if the artifact is expired, challenged, suspended, revoked, or inconsistent with the requested domain or operation-specific policy.

Embodiment variation 6—real-world asset observation. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant real-world asset observation record and committed to a tamper-evident audit log. A downstream verifier denies the operation if the artifact is expired, challenged, suspended, revoked, or inconsistent with the requested domain or operation-specific policy.

Embodiment variation 7—carbon-credit measurement. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant carbon-credit measurement record and committed to a tamper-evident audit log. A downstream verifier denies the operation if the artifact is expired, challenged, suspended, revoked, or inconsistent with the requested domain or operation-specific policy.

Embodiment variation 8—education credentialing. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant education credentialing record and committed to a tamper-evident audit log. A downstream verifier denies the operation if the artifact is expired, challenged, suspended, revoked, or inconsistent with the requested domain or operation-specific policy.

Embodiment variation 9—health event proof. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant health event proof record and committed to a tamper-evident audit log. A downstream verifier denies the operation if the artifact is expired, challenged, suspended, revoked, or inconsistent with the requested domain or operation-specific policy.

Embodiment variation 10—AI-agent delegation. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant AI-agent delegation record and committed to a tamper-evident audit log. A downstream verifier denies the operation if the artifact is expired, challenged, suspended, revoked, or inconsistent with the requested domain or operation-specific policy.

Embodiment variation 11—identity issuance. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant identity issuance record and committed to a tamper-evident audit log. A downstream verifier denies the operation if the artifact is expired, challenged, suspended, revoked, or inconsistent with the requested domain or operation-specific policy.

Embodiment variation 12—wallet authorization. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant wallet authorization record and committed to a tamper-evident audit log. A downstream verifier denies the operation if the artifact is expired, challenged, suspended, revoked, or inconsistent with the requested domain or operation-specific policy.

Embodiment variation 13—minting eligibility. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant minting eligibility record and committed to a tamper-evident audit log. A downstream verifier denies the operation if the artifact is expired, challenged, suspended, revoked, or inconsistent with the requested domain or operation-specific policy.

Embodiment variation 14—NFT certification. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant NFT certification record and committed to a tamper-evident audit log. A downstream verifier denies the operation if the artifact is expired, challenged, suspended, revoked, or inconsistent with the requested domain or operation-specific policy.

Embodiment variation 15—domain-token routing. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant domain-token routing record and committed to a tamper-evident audit log. A downstream verifier denies the operation if the artifact is expired, challenged, suspended, revoked, or inconsistent with the requested domain or operation-specific policy.

Embodiment variation 16—real-world asset observation. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant real-world asset observation record and committed to a tamper-evident audit log. A downstream verifier denies the operation if the artifact is expired, challenged, suspended, revoked, or inconsistent with the requested domain or operation-specific policy.

Embodiment variation 17—carbon-credit measurement. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant carbon-credit measurement record and committed to a tamper-evident audit log. A downstream verifier denies the operation if the artifact is expired, challenged, suspended, revoked, or inconsistent with the requested domain or operation-specific policy.

Embodiment variation 18—education credentialing. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant education credentialing record and committed to a tamper-evident audit log. A downstream verifier denies the operation if the artifact is expired, challenged, suspended, revoked, or inconsistent with the requested domain or operation-specific policy.

Embodiment variation 19—health event proof. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant health event proof record and committed to a tamper-evident audit log. A downstream verifier denies the operation if the artifact is expired, challenged, suspended, revoked, or inconsistent with the requested domain or operation-specific policy.

Embodiment variation 20—AI-agent delegation. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant AI-agent delegation record and committed to a tamper-evident audit log. A downstream verifier denies the operation if the artifact is expired, challenged, suspended, revoked, or inconsistent with the requested domain or operation-specific policy.

Embodiment variation 21—identity issuance. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant identity issuance record and committed to a tamper-evident audit log. A downstream verifier denies the operation if the artifact is expired, challenged, suspended, revoked, or inconsistent with the requested domain or operation-specific policy.

Embodiment variation 22—wallet authorization. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant wallet authorization record and committed to a tamper-evident audit log. A downstream verifier denies the operation if the artifact is expired, challenged, suspended, revoked, or inconsistent with the requested domain or operation-specific policy.

Embodiment variation 23—minting eligibility. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant minting eligibility record and committed to a tamper-evident audit log. A downstream verifier denies the operation if the artifact is expired, challenged, suspended, revoked, or inconsistent with the requested domain or operation-specific policy.

Embodiment variation 24—NFT certification. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant NFT certification record and committed to a tamper-evident audit log. A downstream verifier denies the operation if the artifact is expired, challenged, suspended, revoked, or inconsistent with the requested domain or operation-specific policy.

Embodiment variation 25—domain-token routing. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant domain-token routing record and committed to a tamper-evident audit log. A downstream verifier denies the operation if the artifact is expired, challenged, suspended, revoked, or inconsistent with the requested domain or operation-specific policy.

Embodiment variation 26—real-world asset observation. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant real-world asset observation record and committed to a tamper-evident audit log. A downstream verifier denies the operation if the artifact is expired, challenged, suspended, revoked, or inconsistent with the requested domain or operation-specific policy.

Embodiment variation 27—carbon-credit measurement. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant carbon-credit measurement record and committed to a tamper-evident audit log. A downstream verifier denies the operation if the artifact is expired, challenged, suspended, revoked, or inconsistent with the requested domain or operation-specific policy.

Embodiment variation 28—education credentialing. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant education credentialing record and committed to a tamper-evident audit log. A downstream verifier denies the operation if the artifact is expired, challenged, suspended, revoked, or inconsistent with the requested domain or operation-specific policy.

Embodiment variation 29—health event proof. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant health event proof record and committed to a tamper-evident audit log. A downstream verifier denies the operation if the artifact is expired, challenged, suspended, revoked, or inconsistent with the requested domain or operation-specific policy.

Embodiment variation 30—AI-agent delegation. In this variation, an authorized endpoint receives or generates a behavior-bound signature request. The client or source constructs a canonical behavioral payload containing an identity-anchor reference, a domain hash, a device-context commitment, a temporal marker, a nonce, and a validity window. The local or remote privacy-proof verifier confirms liveness or behavior presence without requiring raw biometric disclosure. The anti-replay state machine consumes the nonce only after canonicalization, domain consistency, and lifecycle status are accepted. The signature artifact is then bound to the relevant AI-agent delegation record and committed to a tamper-evident audit log. A downstream verifier denies the operation if the artifact is expired, challenged, suspended, revoked, or inconsistent with the requested domain or operation-specific policy.

### EXTENDED TECHNICAL EMBODIMENTS FOR EXAMINATION AND INTEROPERABILITY

### ADDITIONAL NON-LIMITING TECHNICAL EMBODIMENTS

Non-limiting embodiment 1—Server Authority Deployment. A server-side signature authority may be deployed as a cloud service, regulated gateway, enterprise appliance, banking identity node, or identity-provider cluster. The authority receives a canonical behavioral payload or commitment package, verifies proof conditions, consumes anti-replay state, and issues a BEI Signature Artifact only when the domain context, identity-anchor reference, validity window, lifecycle status, and audit commitment satisfy the disclosed state machine.

Non-limiting embodiment 2—Client Device Deployment. A client device may be a mobile phone, wearable, vehicle terminal, point-of-interaction terminal, medical sensor, field-inspection device, educational credential terminal, or secure workstation. The client captures local inputs, retains raw sensitive data within a protected execution environment or local storage, and transmits only commitments, proofs, public fields, or canonical payload material needed for the server-side authority or verifier.

Non-limiting embodiment 3—Verifier Endpoint Deployment. A verifier endpoint may be operated by a minting service, wallet, NFT certification service, domain-token router, RWA registry, access-control system, clearing pre-check node, rollback evidence service, or public proof portal. The verifier does not need to possess raw biometric data if the BEI Signature Artifact, proof reference, lifecycle status, audit commitment, and public verification keys satisfy the verifier-gated authority rules.

Non-limiting embodiment 4—Zero-Knowledge Deployment. A zero-knowledge or selective-disclosure deployment may prove that a live person, enrolled device, authorized domain context, and permitted validity window exist without revealing the raw face image, voice sample, exact coordinates, or underlying behavior evidence. The public inputs may include a domain hash, identity-anchor reference, nonce, validity-window commitment, and policy or lifecycle status.

Non-limiting embodiment 5—AI and Deepfake Defense Deployment. A liveness gate may evaluate unpredictable semantic prompts, facial-motion correlation, voice-response timing, device inertial data, sensor fusion, near-field data, and artificial-intelligence-generated impersonation confidence. When a deepfake confidence value exceeds a threshold, the state machine may reject, degrade, challenge, suspend, or require recertification before any BEI Signature Artifact is issued or accepted.

Non-limiting embodiment 6—RWA and Site Observation Deployment. A real-world-asset observation may be certified when an authorized observer, device, or institution produces a behavior-bound proof at a relevant physical site and time window. The resulting BEI Signature Artifact may support carbon-credit measurement, field inspection, delivery confirmation, healthcare service events, education attendance, environmental monitoring, maintenance records, or other physical-world evidence without requiring public disclosure of raw biometric or location evidence.

Non-limiting embodiment 7—Domain Routing Deployment. A domain context may include a domain name, subdomain, endpoint basepoint, namespace identifier, service endpoint, or domain-token reference. The domain hash binds a signature operation to an intended context so that an artifact generated for one domain or endpoint cannot be replayed in another domain or endpoint without failing the domain-consistency condition.

Non-limiting embodiment 8—Lifecycle Deployment. A lifecycle registry may record active, expired, challenged, suspended, recertified, revoked, and audit-committed states. The registry allows downstream systems to distinguish a mathematically valid old signature from a currently authorized BEI Signature Artifact, thereby improving over ordinary digital signatures that remain cryptographically verifiable even after the underlying authority should have expired.

Non-limiting embodiment 9—Audit Deployment. A tamper-evident audit log may store commitments to payload hashes, signature identifiers, lifecycle transitions, verifier decisions, domain contexts, or downstream operation receipts. The audit log may be implemented by an append-only log, Merkle tree, distributed ledger, permissioned ledger, WORM storage, or equivalent integrity-preserving storage.

Non-limiting embodiment 10—Civilizational-Economy Deployment. A civilizational-economy identity infrastructure may use BEI Signature Artifacts to verify behavior, time, contribution, care, learning, health, environmental, delivery, inspection, or other human or institutional events before downstream value-bearing operations are allowed. This deployment remains technical because it depends on machine-readable payloads, proof conditions, lifecycle states, verifier decisions, and audit commitments rather than on adoption of any social or economic theory.

Non-limiting embodiment 11—International Standard Compatibility Deployment. The BEI Protocol may interoperate with W3C decentralized identifiers, W3C verifiable credentials, FIDO/WebAuthn, ISO 20022 messages, X.509 public-key infrastructure, DNSSEC, DANE, TLS, OAuth, OpenID Connect, zero-knowledge proof frameworks, distributed-ledger standards, or equivalent standards. Such compatibility may be implemented through adapters while preserving the BEI Signature Artifact format and lifecycle semantics.

Non-limiting embodiment 12—Policy-Controlled Operation Deployment. A downstream operation may be policy controlled when execution depends on identity context, domain context, validity window, lifecycle state, audit commitment, proof acceptance, and anti-replay state. The disclosed verifier-gated authority may therefore decide permission, denial, conditional allowance, challenge, suspension, recertification, revocation, or rollback-evidence status for a protected operation.

Non-limiting embodiment 13—Minting Eligibility Deployment. A minting endpoint may require a valid BEI Signature Artifact before issuing a behavior-based value unit, time-currency unit, service unit, proof NFT, tokenized receipt, credential, reward, or similar digital object. The endpoint may deny minting when the artifact has expired, the nonce has been consumed, the domain hash is inconsistent, the lifecycle status is suspended, or the audit commitment cannot be verified.

Non-limiting embodiment 14—Wallet Authorization Deployment. A wallet authorization system may require a BEI Signature Artifact for high-risk transfers, account recovery, credential issuance, key rotation, delegation, or AI-agent action approval. This provides a technical difference over ordinary private-key signing because the system verifies behavior presence, lifecycle status, and domain-bound authority instead of merely proving possession of a private key.

Non-limiting embodiment 15—NFT Certification Deployment. An NFT certification endpoint may bind a BEI Signature Artifact to metadata of a non-fungible token or equivalent record. The bound artifact may indicate that a human action, site observation, domain-token route, education event, medical service event, inspection, contribution, or other behavior-related evidence was verified under the disclosed state machine.

Non-limiting embodiment 16—Access-Control Deployment. An access-control system may allow physical or digital access only if a BEI Signature Artifact remains active and satisfies a verifier-gated rule. The rule may require a liveness score above a threshold, a current validity window, an enrolled device salt, a matching domain hash, and an audit-log commitment.

Non-limiting embodiment 17—Clearing Compliance Deployment. A clearing or transaction-precheck service may use a BEI Signature Artifact as a precondition for entry into a transaction rail. The artifact may provide evidence that a user or authorized source was present, that a domain and identity context were bound, and that lifecycle and audit conditions were satisfied before clearing compliance or rollback evidence is accepted.

Non-limiting embodiment 18—Rollback Evidence Deployment. A rollback, clawback, or dispute-resolution service may verify a BEI Signature Artifact, lifecycle record, audit commitment, domain hash, and validity window before generating evidence for reversal, suspension, recertification, or challenge. The service may use the artifact as a technical evidence object rather than as a mere descriptive transaction memo.

Non-limiting embodiment 19—Endpoint Domain Deployment. Non-limiting endpoint domains may publish identity, signature, proof, minting, wallet, ecosystem, ATMS, rollback, or clawback endpoints. Such domain names are examples of domain-context inputs and do not limit the invention to a particular DNS registry, domain owner, top-level domain, or service provider.

Non-limiting embodiment 20—Single-Actor Server Path. A single server-side actor may infringe a system implementation by receiving a canonical payload, verifying privacy and liveness proof material, consuming anti-replay state, issuing a BEI Signature Artifact, and writing lifecycle and audit commitments. This implementation does not require control of the client hardware or the downstream verifier.

Non-limiting embodiment 21—Single-Actor Client Path. A single client-side actor may practice a method implementation by capturing multimodal inputs, generating a device salt, constructing a canonical payload, generating a privacy-preserving proof, transmitting the payload or commitment, receiving a BEI Signature Artifact, and binding it to a credential or operation request.

Non-limiting embodiment 22—Single-Actor Verifier Path. A single verifier actor may practice a verifier implementation by receiving a BEI Signature Artifact, verifying a payload hash and public-key signature, retrieving lifecycle status, checking domain and validity-window conditions, checking audit-log commitment, and allowing or denying a downstream operation.

Non-limiting embodiment 23—Portable Proof Deployment. A BEI Signature Artifact may be portable between systems while preserving privacy because it can include a payload hash, signature value, public-key identifier, lifecycle pointer, domain hash, proof reference, and audit-log commitment rather than raw evidence. This enables third-party verification without transferring raw biometric templates or exact location coordinates.

Non-limiting embodiment 24—Hardware-Secured Deployment. A hardware-secured embodiment may store signing keys, device salts, liveness models, proof secrets, or nonce registers in a secure enclave, trusted execution environment, secure element, hardware security module, or equivalent protected component. The state machine may deny signature issuance when attestation from the protected component fails.

Non-limiting embodiment 25—Post-Quantum Deployment. A cryptographic signature engine may use post-quantum signatures, hybrid signatures, threshold signatures, or algorithm-agile signing policies. The canonical payload, lifecycle registry, and verifier-gated authority remain applicable regardless of whether the public-key algorithm is ECDSA, EdDSA, lattice-based, hash-based, or another public-key scheme.

Non-limiting embodiment 26—API Deployment. An application programming interface may expose endpoints for payload submission, proof verification, artifact issuance, lifecycle query, verifier decision, audit commitment, recertification, suspension, revocation, or rollback-evidence generation. API responses may include status codes corresponding to accepted, rejected, degraded, challenged, signed, bound, expired, suspended, recertified, revoked, or audit-committed states.

Non-limiting embodiment 27—Event Taxonomy Deployment. A behavior category may be represented using an occupation code, service code, health event code, education event code, environmental action code, delivery code, inspection code, care code, or other taxonomy. The category may be included in the canonical payload or represented by a commitment so that downstream operations can apply policy without exposing unnecessary personal data.

Non-limiting embodiment 28—Privacy Boundary Deployment. A privacy boundary may separate local raw evidence from public verifier inputs. Raw face images, voice samples, exact coordinates, or health measurements may remain on the client device or within a protected source, while the public verifier receives commitments, proof references, threshold results, or derived gate statuses.

Non-limiting embodiment 29—Evidence Commitment Deployment. An evidence commitment may bind off-chain records, sensor samples, institutional attestations, witness signatures, device measurements, or behavior events to a canonical payload. The commitment may be verified later by revealing selected evidence, providing a zero-knowledge proof, or checking a tamper-evident audit-log path.

Non-limiting embodiment 30—Policy Version Deployment. A policy-version identifier may specify which liveness thresholds, validity windows, domain rules, proof schemes, lifecycle statuses, or downstream eligibility rules apply to a signature operation. The policy version may be included in the canonical payload, lifecycle registry, verifier registry, or audit log.

Non-limiting embodiment 31—Delegation Deployment. A user may delegate limited authority to an agent, device, organization, or automated process only after a BEI Signature Artifact is generated and bound to a validity window, scope, domain context, and lifecycle state. The delegation may expire, be challenged, be suspended, or require recertification before further downstream operations are allowed.

Non-limiting embodiment 32—AI-Agent Authorization Deployment. An AI-agent authorization system may require human behavior-bound recertification before an artificial-intelligence agent performs a transfer, credential issuance, data access, order, clearing entry, or other protected operation. The BEI Signature Artifact provides a machine-verifiable link between human approval and agent action authority.

Non-limiting embodiment 33—Interoperable Credential Deployment. A verifiable credential, decentralized identifier document, passkey credential, X.509 certificate, wallet credential, or domain endpoint record may carry a reference to a BEI Signature Artifact. The reference may include an artifact identifier, payload hash, lifecycle endpoint, public-key identifier, or audit-log commitment.

Non-limiting embodiment 34—Resilience Deployment. The state machine may operate in online, offline, intermittent connectivity, or low-latency environments by caching policy, nonce ranges, public keys, or lifecycle status subject to expiration constraints. When cached state becomes stale, the verifier may require recertification before allowing a downstream operation.

Non-limiting embodiment 35—Revocation Deployment. Revocation may be triggered by key compromise, biometric mismatch, device mismatch, domain mismatch, user request, policy challenge, fraud signal, deepfake signal, regulatory condition, audit failure, or expiration. A revoked BEI Signature Artifact may remain historically auditable while losing verifier-gated authority for future operations.

Non-limiting embodiment 36—Claim-Support Deployment. Each disclosed module includes inputs, outputs, and state effects. Each process maps to a data structure or state transition, and each drawing illustrates at least one claim-relevant relationship among the server-side authority, client-device method, verifier medium, canonical payload, anti-replay state machine, lifecycle registry, audit log, or downstream endpoint.

### ADDITIONAL FIELD-OF-USE IMPLEMENTATIONS

Wallet recovery: The verifier requires a valid BEI Signature Artifact before rotating keys, restoring access, or approving a delegated recovery agent. If a device mismatch or deepfake signal is detected, the lifecycle registry moves the artifact to challenged or suspended rather than allowing recovery.

High-value transfer authorization: A wallet or payment endpoint requires a fresh artifact bound to a domain hash, validity window, and nonce. A stale or reused artifact cannot authorize the transfer, and the audit log records the denial reason without exposing raw biometrics.

NFT provenance certification: A creator or certifier binds a behavior event to an NFT metadata record. The metadata stores a payload hash, lifecycle pointer, public-key identifier, and audit-log commitment so that future verifiers can validate authenticity without relying on a centralized statement.

Time-currency eligibility: A time-denominated value unit is not minted merely because a user asserts time spent. The minting endpoint verifies an active BEI Signature Artifact whose payload includes time-window and behavior-category commitments.

Carbon-credit site observation: An auditor or sensor operator produces an artifact bound to a site-domain hash, time window, location commitment, device salt, and observation evidence commitment before a carbon-credit record is recognized.

Education credential issuance: A school, instructor, or learning terminal uses the artifact to verify that a learner or educator completed a behavior event, examination, attendance event, or certification act in a privacy-preserving manner.

Healthcare or care event proof: A patient, clinician, caregiver, or medical device produces an artifact for an adherence, visit, preventive care, or care-work event, with raw health data protected by commitments or selective disclosure.

AI agent supervision: A human grants an AI agent limited authority only when a fresh artifact proves live consent, domain context, and validity window. The verifier denies out-of-scope agent actions.

Domain-token route authorization: A domain or subdomain endpoint accepts a routing or minting request only when the domain hash in the artifact matches the endpoint basepoint and the lifecycle state is active.

Clearing precheck and rollback evidence: A transaction rail can use the artifact as evidence that an identity, behavior, time, and domain context were validated before an A-C-T transaction, rollback, clawback, or compliance hold workflow.

### ADDITIONAL EXAMPLES OF FAILURE CODES AND VERIFIER RESPONSES

### ADDITIONAL API AND MESSAGE EXAMPLES

### DETAILED FAILURE-CODE AND VERIFIER-RESPONSE EMBODIMENTS

Failure code REJECT_PRIVACY_PROOF: In some embodiments, a verifier, authority, or client gate produces the code REJECT_PRIVACY_PROOF when privacy-preserving proof does not verify against public inputs. The code may be written into a lifecycle registry, returned through an application programming interface, included in an audit-log commitment, or used to select an allow, deny, challenge, suspend, recertify, revoke, or conditional-allow transition.

Failure code REJECT_CANONICAL_ENCODING: In some embodiments, a verifier, authority, or client gate produces the code REJECT_CANONICAL_ENCODING when payload encoding cannot be reproduced deterministically. The code may be written into a lifecycle registry, returned through an application programming interface, included in an audit-log commitment, or used to select an allow, deny, challenge, suspend, recertify, revoke, or conditional-allow transition.

Failure code REJECT_REPLAY_STATE: In some embodiments, a verifier, authority, or client gate produces the code REJECT_REPLAY_STATE when nonce, counter, or prior signature hash has already been consumed. The code may be written into a lifecycle registry, returned through an application programming interface, included in an audit-log commitment, or used to select an allow, deny, challenge, suspend, recertify, revoke, or conditional-allow transition.

Failure code REJECT_DOMAIN_CONTEXT: In some embodiments, a verifier, authority, or client gate produces the code REJECT_DOMAIN_CONTEXT when domain hash or endpoint basepoint is inconsistent with the requested operation. The code may be written into a lifecycle registry, returned through an application programming interface, included in an audit-log commitment, or used to select an allow, deny, challenge, suspend, recertify, revoke, or conditional-allow transition.

Failure code REJECT_IDENTITY_ANCHOR: In some embodiments, a verifier, authority, or client gate produces the code REJECT_IDENTITY_ANCHOR when identity-anchor reference does not bind to the claimed BEI identity. The code may be written into a lifecycle registry, returned through an application programming interface, included in an audit-log commitment, or used to select an allow, deny, challenge, suspend, recertify, revoke, or conditional-allow transition.

Failure code REJECT_VALIDITY_WINDOW: In some embodiments, a verifier, authority, or client gate produces the code REJECT_VALIDITY_WINDOW when timestamp or validity interval is stale, premature, or expired. The code may be written into a lifecycle registry, returned through an application programming interface, included in an audit-log commitment, or used to select an allow, deny, challenge, suspend, recertify, revoke, or conditional-allow transition.

Failure code REJECT_DEVICE_CONTEXT: In some embodiments, a verifier, authority, or client gate produces the code REJECT_DEVICE_CONTEXT when device salt, device attestation, or secure-enclave statement does not match enrolled state. The code may be written into a lifecycle registry, returned through an application programming interface, included in an audit-log commitment, or used to select an allow, deny, challenge, suspend, recertify, revoke, or conditional-allow transition.

Failure code REJECT_LIVENESS: In some embodiments, a verifier, authority, or client gate produces the code REJECT_LIVENESS when liveness score, sensor correlation, or prompt-response evidence is insufficient. The code may be written into a lifecycle registry, returned through an application programming interface, included in an audit-log commitment, or used to select an allow, deny, challenge, suspend, recertify, revoke, or conditional-allow transition.

Failure code REJECT_DEEPFAKE_RISK: In some embodiments, a verifier, authority, or client gate produces the code REJECT_DEEPFAKE_RISK when AI-generated impersonation confidence exceeds a configured threshold. The code may be written into a lifecycle registry, returned through an application programming interface, included in an audit-log commitment, or used to select an allow, deny, challenge, suspend, recertify, revoke, or conditional-allow transition.

Failure code REJECT_AUDIT_COMMITMENT: In some embodiments, a verifier, authority, or client gate produces the code REJECT_AUDIT_COMMITMENT when audit-log path, Merkle inclusion proof, or commitment verification fails. The code may be written into a lifecycle registry, returned through an application programming interface, included in an audit-log commitment, or used to select an allow, deny, challenge, suspend, recertify, revoke, or conditional-allow transition.

Failure code CHALLENGE_REQUIRED: In some embodiments, a verifier, authority, or client gate produces the code CHALLENGE_REQUIRED when one or more gate results requires step-up authentication or recertification. The code may be written into a lifecycle registry, returned through an application programming interface, included in an audit-log commitment, or used to select an allow, deny, challenge, suspend, recertify, revoke, or conditional-allow transition.

Failure code SUSPEND_LIFECYCLE: In some embodiments, a verifier, authority, or client gate produces the code SUSPEND_LIFECYCLE when lifecycle status requires temporary suspension before the operation proceeds. The code may be written into a lifecycle registry, returned through an application programming interface, included in an audit-log commitment, or used to select an allow, deny, challenge, suspend, recertify, revoke, or conditional-allow transition.

Failure code RECERTIFY_REQUIRED: In some embodiments, a verifier, authority, or client gate produces the code RECERTIFY_REQUIRED when artifact age, policy update, or domain change requires recertification. The code may be written into a lifecycle registry, returned through an application programming interface, included in an audit-log commitment, or used to select an allow, deny, challenge, suspend, recertify, revoke, or conditional-allow transition.

Failure code REVOKE_ARTIFACT: In some embodiments, a verifier, authority, or client gate produces the code REVOKE_ARTIFACT when fraud signal, compromise, user request, or administrative event revokes authority. The code may be written into a lifecycle registry, returned through an application programming interface, included in an audit-log commitment, or used to select an allow, deny, challenge, suspend, recertify, revoke, or conditional-allow transition.

Failure code ALLOW_CONDITIONAL: In some embodiments, a verifier, authority, or client gate produces the code ALLOW_CONDITIONAL when operation is allowed only within a limited scope, amount, domain, or time window. The code may be written into a lifecycle registry, returned through an application programming interface, included in an audit-log commitment, or used to select an allow, deny, challenge, suspend, recertify, revoke, or conditional-allow transition.

Failure code ALLOW_FULL: In some embodiments, a verifier, authority, or client gate produces the code ALLOW_FULL when all required gate, lifecycle, domain, proof, and audit conditions are satisfied. The code may be written into a lifecycle registry, returned through an application programming interface, included in an audit-log commitment, or used to select an allow, deny, challenge, suspend, recertify, revoke, or conditional-allow transition.

### DETAILED API AND MESSAGE EMBODIMENTS

API operation submitPayload: In some embodiments, an interface operation named submitPayload or an equivalent operation receives canonical payload fields, commitment references, proof references, domain context, and identity-anchor data. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation verifyProof: In some embodiments, an interface operation named verifyProof or an equivalent operation checks privacy-preserving proof public inputs against the canonical payload or commitment. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation consumeNonce: In some embodiments, an interface operation named consumeNonce or an equivalent operation atomically marks a nonce, counter, or uniqueness value as consumed. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation issueArtifact: In some embodiments, an interface operation named issueArtifact or an equivalent operation returns a BEI Signature Artifact with signature value, public-key identifier, lifecycle pointer, and audit commitment. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation queryLifecycle: In some embodiments, an interface operation named queryLifecycle or an equivalent operation returns active, challenged, suspended, recertified, revoked, expired, or audit-committed status. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation verifyArtifact: In some embodiments, an interface operation named verifyArtifact or an equivalent operation checks signature value, payload hash, lifecycle status, domain hash, validity window, and audit-log commitment. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation requestChallenge: In some embodiments, an interface operation named requestChallenge or an equivalent operation initiates step-up liveness, device, domain, or privacy-proof recertification. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation suspendArtifact: In some embodiments, an interface operation named suspendArtifact or an equivalent operation places a temporary hold on verifier-gated authority without deleting audit history. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation revokeArtifact: In some embodiments, an interface operation named revokeArtifact or an equivalent operation records permanent or policy-based revocation of future authority. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation writeAuditCommitment: In some embodiments, an interface operation named writeAuditCommitment or an equivalent operation stores a commitment or inclusion path in a tamper-evident audit log. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation registerDomainEndpoint: In some embodiments, an interface operation named registerDomainEndpoint or an equivalent operation binds a domain context or endpoint basepoint to verifier registry metadata. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

API operation mapToExternalStandard: In some embodiments, an interface operation named mapToExternalStandard or an equivalent operation maps an artifact reference or lifecycle status to an external credential or messaging standard. The operation may be exposed by a client device, server-side signature authority, verifier endpoint, wallet, minting endpoint, standards gateway, domain endpoint, access-control terminal, or clearing precheck node, and may return a signed response, status code, lifecycle pointer, or audit commitment.

### DETAILED CANONICAL PAYLOAD FIELD EMBODIMENTS

Canonical payload field payload_version: In some embodiments, the field payload_version distinguishes canonicalization and protocol interpretation rules. The field may be carried in a canonical byte sequence, committed by a hash, represented by a selective-disclosure statement, mapped to an external credential, or verified through a zero-knowledge or equivalent privacy-preserving proof.

Canonical payload field identity_anchor_ref: In some embodiments, the field identity_anchor_ref references a sovereign identity anchor or equivalent identity record. The field may be carried in a canonical byte sequence, committed by a hash, represented by a selective-disclosure statement, mapped to an external credential, or verified through a zero-knowledge or equivalent privacy-preserving proof.

Canonical payload field bei_identity_ref: In some embodiments, the field bei_identity_ref references a Behavioral Economics Identity representation or subject record. The field may be carried in a canonical byte sequence, committed by a hash, represented by a selective-disclosure statement, mapped to an external credential, or verified through a zero-knowledge or equivalent privacy-preserving proof.

Canonical payload field domain_basepoint: In some embodiments, the field domain_basepoint identifies the domain, subdomain, endpoint, or namespace context. The field may be carried in a canonical byte sequence, committed by a hash, represented by a selective-disclosure statement, mapped to an external credential, or verified through a zero-knowledge or equivalent privacy-preserving proof.

Canonical payload field domain_hash: In some embodiments, the field domain_hash commits the operation to a domain context and prevents cross-domain replay. The field may be carried in a canonical byte sequence, committed by a hash, represented by a selective-disclosure statement, mapped to an external credential, or verified through a zero-knowledge or equivalent privacy-preserving proof.

Canonical payload field nonce: In some embodiments, the field nonce provides uniqueness within a validity window and anti-replay state. The field may be carried in a canonical byte sequence, committed by a hash, represented by a selective-disclosure statement, mapped to an external credential, or verified through a zero-knowledge or equivalent privacy-preserving proof.

Canonical payload field validity_window_start: In some embodiments, the field validity_window_start defines the beginning of the permitted time interval. The field may be carried in a canonical byte sequence, committed by a hash, represented by a selective-disclosure statement, mapped to an external credential, or verified through a zero-knowledge or equivalent privacy-preserving proof.

Canonical payload field validity_window_end: In some embodiments, the field validity_window_end defines expiration of the permitted time interval. The field may be carried in a canonical byte sequence, committed by a hash, represented by a selective-disclosure statement, mapped to an external credential, or verified through a zero-knowledge or equivalent privacy-preserving proof.

Canonical payload field device_salt: In some embodiments, the field device_salt binds a device or secure component without exposing raw device identifiers. The field may be carried in a canonical byte sequence, committed by a hash, represented by a selective-disclosure statement, mapped to an external credential, or verified through a zero-knowledge or equivalent privacy-preserving proof.

Canonical payload field behavior_category: In some embodiments, the field behavior_category identifies a behavior event class or committed taxonomy label. The field may be carried in a canonical byte sequence, committed by a hash, represented by a selective-disclosure statement, mapped to an external credential, or verified through a zero-knowledge or equivalent privacy-preserving proof.

Canonical payload field evidence_commitment: In some embodiments, the field evidence_commitment commits to off-chain or local evidence without disclosing raw evidence. The field may be carried in a canonical byte sequence, committed by a hash, represented by a selective-disclosure statement, mapped to an external credential, or verified through a zero-knowledge or equivalent privacy-preserving proof.

Canonical payload field privacy_proof_ref: In some embodiments, the field privacy_proof_ref references a proof, credential presentation, or attestation statement. The field may be carried in a canonical byte sequence, committed by a hash, represented by a selective-disclosure statement, mapped to an external credential, or verified through a zero-knowledge or equivalent privacy-preserving proof.

Canonical payload field policy_version: In some embodiments, the field policy_version identifies verification thresholds, lifecycle rules, or domain policies. The field may be carried in a canonical byte sequence, committed by a hash, represented by a selective-disclosure statement, mapped to an external credential, or verified through a zero-knowledge or equivalent privacy-preserving proof.

Canonical payload field expiration_parameter: In some embodiments, the field expiration_parameter sets a hard or soft expiration condition for downstream authority. The field may be carried in a canonical byte sequence, committed by a hash, represented by a selective-disclosure statement, mapped to an external credential, or verified through a zero-knowledge or equivalent privacy-preserving proof.

Canonical payload field prior_signature_hash: In some embodiments, the field prior_signature_hash binds renewal, challenge, or recertification to prior lifecycle state. The field may be carried in a canonical byte sequence, committed by a hash, represented by a selective-disclosure statement, mapped to an external credential, or verified through a zero-knowledge or equivalent privacy-preserving proof.

Canonical payload field audit_log_commitment: In some embodiments, the field audit_log_commitment links the artifact to tamper-evident evidence of issuance or transition. The field may be carried in a canonical byte sequence, committed by a hash, represented by a selective-disclosure statement, mapped to an external credential, or verified through a zero-knowledge or equivalent privacy-preserving proof.

### DETAILED STATE-MACHINE TRANSITION EMBODIMENTS

State new: In some embodiments, the disclosed state machine includes a state identified as new or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State captured: In some embodiments, the disclosed state machine includes a state identified as captured or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State proof-generated: In some embodiments, the disclosed state machine includes a state identified as proof-generated or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State submitted: In some embodiments, the disclosed state machine includes a state identified as submitted or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State canonicalized: In some embodiments, the disclosed state machine includes a state identified as canonicalized or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State privacy-verified: In some embodiments, the disclosed state machine includes a state identified as privacy-verified or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State domain-bound: In some embodiments, the disclosed state machine includes a state identified as domain-bound or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State nonce-consumed: In some embodiments, the disclosed state machine includes a state identified as nonce-consumed or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State identity-bound: In some embodiments, the disclosed state machine includes a state identified as identity-bound or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State signed: In some embodiments, the disclosed state machine includes a state identified as signed or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State metadata-bound: In some embodiments, the disclosed state machine includes a state identified as metadata-bound or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State active: In some embodiments, the disclosed state machine includes a state identified as active or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State challenged: In some embodiments, the disclosed state machine includes a state identified as challenged or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State degraded: In some embodiments, the disclosed state machine includes a state identified as degraded or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State suspended: In some embodiments, the disclosed state machine includes a state identified as suspended or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State recertified: In some embodiments, the disclosed state machine includes a state identified as recertified or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State revoked: In some embodiments, the disclosed state machine includes a state identified as revoked or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State expired: In some embodiments, the disclosed state machine includes a state identified as expired or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State audit-committed: In some embodiments, the disclosed state machine includes a state identified as audit-committed or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State downstream-allowed: In some embodiments, the disclosed state machine includes a state identified as downstream-allowed or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

State downstream-denied: In some embodiments, the disclosed state machine includes a state identified as downstream-denied or an equivalent state. Entry into the state is controlled by one or more gate outputs, and exit from the state is recorded by a lifecycle registry or tamper-evident audit log so that a downstream verifier can distinguish historical cryptographic validity from present verifier-gated authority.

### DETAILED INTERNATIONAL COMPATIBILITY EMBODIMENTS

Compatibility with W3C decentralized identifiers: In some embodiments, the BEI Protocol maps to, extends, transports, or interoperates with W3C decentralized identifiers while preserving BEI Signature Artifact semantics, domain-context binding, lifecycle-state verification, and verifier-gated authority. Such compatibility is optional and does not require the claims to be limited to that external standard.

Compatibility with W3C verifiable credentials: In some embodiments, the BEI Protocol maps to, extends, transports, or interoperates with W3C verifiable credentials while preserving BEI Signature Artifact semantics, domain-context binding, lifecycle-state verification, and verifier-gated authority. Such compatibility is optional and does not require the claims to be limited to that external standard.

Compatibility with FIDO/WebAuthn: In some embodiments, the BEI Protocol maps to, extends, transports, or interoperates with FIDO/WebAuthn while preserving BEI Signature Artifact semantics, domain-context binding, lifecycle-state verification, and verifier-gated authority. Such compatibility is optional and does not require the claims to be limited to that external standard.

Compatibility with ISO 20022 financial messages: In some embodiments, the BEI Protocol maps to, extends, transports, or interoperates with ISO 20022 financial messages while preserving BEI Signature Artifact semantics, domain-context binding, lifecycle-state verification, and verifier-gated authority. Such compatibility is optional and does not require the claims to be limited to that external standard.

Compatibility with X.509 public-key infrastructure: In some embodiments, the BEI Protocol maps to, extends, transports, or interoperates with X.509 public-key infrastructure while preserving BEI Signature Artifact semantics, domain-context binding, lifecycle-state verification, and verifier-gated authority. Such compatibility is optional and does not require the claims to be limited to that external standard.

Compatibility with DNSSEC: In some embodiments, the BEI Protocol maps to, extends, transports, or interoperates with DNSSEC while preserving BEI Signature Artifact semantics, domain-context binding, lifecycle-state verification, and verifier-gated authority. Such compatibility is optional and does not require the claims to be limited to that external standard.

Compatibility with DANE: In some embodiments, the BEI Protocol maps to, extends, transports, or interoperates with DANE while preserving BEI Signature Artifact semantics, domain-context binding, lifecycle-state verification, and verifier-gated authority. Such compatibility is optional and does not require the claims to be limited to that external standard.

Compatibility with TLS: In some embodiments, the BEI Protocol maps to, extends, transports, or interoperates with TLS while preserving BEI Signature Artifact semantics, domain-context binding, lifecycle-state verification, and verifier-gated authority. Such compatibility is optional and does not require the claims to be limited to that external standard.

Compatibility with OAuth: In some embodiments, the BEI Protocol maps to, extends, transports, or interoperates with OAuth while preserving BEI Signature Artifact semantics, domain-context binding, lifecycle-state verification, and verifier-gated authority. Such compatibility is optional and does not require the claims to be limited to that external standard.

Compatibility with OpenID Connect: In some embodiments, the BEI Protocol maps to, extends, transports, or interoperates with OpenID Connect while preserving BEI Signature Artifact semantics, domain-context binding, lifecycle-state verification, and verifier-gated authority. Such compatibility is optional and does not require the claims to be limited to that external standard.

Compatibility with zero-knowledge proof frameworks: In some embodiments, the BEI Protocol maps to, extends, transports, or interoperates with zero-knowledge proof frameworks while preserving BEI Signature Artifact semantics, domain-context binding, lifecycle-state verification, and verifier-gated authority. Such compatibility is optional and does not require the claims to be limited to that external standard.

Compatibility with distributed-ledger standards: In some embodiments, the BEI Protocol maps to, extends, transports, or interoperates with distributed-ledger standards while preserving BEI Signature Artifact semantics, domain-context binding, lifecycle-state verification, and verifier-gated authority. Such compatibility is optional and does not require the claims to be limited to that external standard.

Compatibility with hardware security module standards: In some embodiments, the BEI Protocol maps to, extends, transports, or interoperates with hardware security module standards while preserving BEI Signature Artifact semantics, domain-context binding, lifecycle-state verification, and verifier-gated authority. Such compatibility is optional and does not require the claims to be limited to that external standard.

Compatibility with trusted-execution attestation interfaces: In some embodiments, the BEI Protocol maps to, extends, transports, or interoperates with trusted-execution attestation interfaces while preserving BEI Signature Artifact semantics, domain-context binding, lifecycle-state verification, and verifier-gated authority. Such compatibility is optional and does not require the claims to be limited to that external standard.

Compatibility with secure element credential formats: In some embodiments, the BEI Protocol maps to, extends, transports, or interoperates with secure element credential formats while preserving BEI Signature Artifact semantics, domain-context binding, lifecycle-state verification, and verifier-gated authority. Such compatibility is optional and does not require the claims to be limited to that external standard.

Compatibility with selective-disclosure credential formats: In some embodiments, the BEI Protocol maps to, extends, transports, or interoperates with selective-disclosure credential formats while preserving BEI Signature Artifact semantics, domain-context binding, lifecycle-state verification, and verifier-gated authority. Such compatibility is optional and does not require the claims to be limited to that external standard.

### DETAILED FIELD-OF-USE EMBODIMENTS

Field-of-use embodiment for identity-token issuance: In some embodiments, a downstream endpoint associated with identity-token issuance requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for wallet authorization: In some embodiments, a downstream endpoint associated with wallet authorization requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for high-value transfer approval: In some embodiments, a downstream endpoint associated with high-value transfer approval requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for account recovery: In some embodiments, a downstream endpoint associated with account recovery requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for key rotation: In some embodiments, a downstream endpoint associated with key rotation requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for NFT certification: In some embodiments, a downstream endpoint associated with NFT certification requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for domain-token routing: In some embodiments, a downstream endpoint associated with domain-token routing requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for BEIMINT eligibility: In some embodiments, a downstream endpoint associated with BEIMINT eligibility requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for time-currency unit issuance: In some embodiments, a downstream endpoint associated with time-currency unit issuance requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for RWA observation certification: In some embodiments, a downstream endpoint associated with RWA observation certification requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for carbon-credit site verification: In some embodiments, a downstream endpoint associated with carbon-credit site verification requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for healthcare event proof: In some embodiments, a downstream endpoint associated with healthcare event proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for education credential issuance: In some embodiments, a downstream endpoint associated with education credential issuance requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for delivery and inspection proof: In some embodiments, a downstream endpoint associated with delivery and inspection proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for caregiving contribution proof: In some embodiments, a downstream endpoint associated with caregiving contribution proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for AI-agent delegation: In some embodiments, a downstream endpoint associated with AI-agent delegation requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for access-control entry: In some embodiments, a downstream endpoint associated with access-control entry requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for clearing compliance precheck: In some embodiments, a downstream endpoint associated with clearing compliance precheck requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for rollback evidence generation: In some embodiments, a downstream endpoint associated with rollback evidence generation requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for clawback evidence support: In some embodiments, a downstream endpoint associated with clawback evidence support requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for public proof portal verification: In some embodiments, a downstream endpoint associated with public proof portal verification requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for enterprise workforce credentialing: In some embodiments, a downstream endpoint associated with enterprise workforce credentialing requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for government benefit eligibility proof: In some embodiments, a downstream endpoint associated with government benefit eligibility proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for supply-chain custody proof: In some embodiments, a downstream endpoint associated with supply-chain custody proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for environmental monitoring proof: In some embodiments, a downstream endpoint associated with environmental monitoring proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for insurance claim observation: In some embodiments, a downstream endpoint associated with insurance claim observation requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for legal service-of-process proof: In some embodiments, a downstream endpoint associated with legal service-of-process proof requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for notarial event verification: In some embodiments, a downstream endpoint associated with notarial event verification requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for tax or reporting evidence commitment: In some embodiments, a downstream endpoint associated with tax or reporting evidence commitment requires a valid BEI Signature Artifact before allowing the protected operation. The verifier may check an identity-anchor reference, domain hash, validity window, anti-replay state, lifecycle status, privacy-preserving proof, and audit-log commitment before granting authority.

Field-of-use embodiment for cross-border remittance authorization: In some embodiments, a downstream endpoint associated with cross-border remittance authorization requires a valid BEI Signature Artifact before allowing the protected operation. The verifier may check an identity-anchor reference, domain hash, validity window, anti-replay state, lifecycle status, privacy-preserving proof, and audit-log commitment before granting authority.

### DETAILED SECURITY ADVANTAGE EMBODIMENTS

Technical advantage—stolen-key resistance: In some embodiments, the disclosed ordered combination provides stolen-key resistance by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—replay resistance: In some embodiments, the disclosed ordered combination provides replay resistance by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—cross-domain replay prevention: In some embodiments, the disclosed ordered combination provides cross-domain replay prevention by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—privacy preservation: In some embodiments, the disclosed ordered combination provides privacy preservation by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—deepfake resistance: In some embodiments, the disclosed ordered combination provides deepfake resistance by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—portable verification: In some embodiments, the disclosed ordered combination provides portable verification by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—lifecycle revocation: In some embodiments, the disclosed ordered combination provides lifecycle revocation by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—auditability: In some embodiments, the disclosed ordered combination provides auditability by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—algorithm agility: In some embodiments, the disclosed ordered combination provides algorithm agility by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—chain neutrality: In some embodiments, the disclosed ordered combination provides chain neutrality by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—single-actor deployability: In some embodiments, the disclosed ordered combination provides single-actor deployability by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—standards interoperability: In some embodiments, the disclosed ordered combination provides standards interoperability by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—raw biometric minimization: In some embodiments, the disclosed ordered combination provides raw biometric minimization by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—domain-bound authority: In some embodiments, the disclosed ordered combination provides domain-bound authority by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—policy-controlled operation gating: In some embodiments, the disclosed ordered combination provides policy-controlled operation gating by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—tamper evidence: In some embodiments, the disclosed ordered combination provides tamper evidence by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—recertification control: In some embodiments, the disclosed ordered combination provides recertification control by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—offline resilience: In some embodiments, the disclosed ordered combination provides offline resilience by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—failure-code determinism: In some embodiments, the disclosed ordered combination provides failure-code determinism by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

Technical advantage—external verifier reproducibility: In some embodiments, the disclosed ordered combination provides external verifier reproducibility by requiring the canonical behavioral payload, privacy-preserving proof, anti-replay state, identity-and-domain binding, lifecycle registry, BEI Signature Artifact generation, verifier decision, and audit commitment to operate together before a downstream operation receives authority.

### DETAILED CLAIM-SUPPORT EMBODIMENTS

Claim-support embodiment 1: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 2: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 3: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 4: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 5: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 6: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 7: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 8: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 9: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 10: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 11: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 12: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 13: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 14: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 15: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 16: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 17: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 18: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 19: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 20: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 21: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 22: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 23: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 24: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 25: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 26: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 27: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 28: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 29: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 30: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 31: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 32: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 33: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 34: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 35: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 36: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 37: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 38: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 39: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

Claim-support embodiment 40: The disclosed modules may be arranged so that each module has defined inputs, defined outputs, and a state effect. For example, a payload-ingress interface outputs a canonical payload or commitment; a privacy-proof verifier outputs accept, reject, degrade, or challenge status; an anti-replay state machine outputs consumed, unconsumed, or invalid state; a lifecycle registry outputs active, suspended, recertified, revoked, or expired status; and a verifier endpoint outputs an operation permission, denial, conditional allowance, or rollback-evidence decision.

### DETAILED IMPLEMENTATION TABLES AND NON-LIMITING PROTOCOL PROFILES

The following protocol profiles are non-limiting examples of how the same BEI Signature Artifact and verifier-gated authority rules may be used across different fields of use without changing the core state-machine architecture.

Protocol profile 1—identity issuance: In a non-limiting profile for identity-anchor issuance, BEI identity activation, or credential onboarding, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 2—wallet recovery: In a non-limiting profile for wallet recovery, step-up authorization, device replacement, or key-rotation approval, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 3—token minting: In a non-limiting profile for minting eligibility, behavior-currency issuance, time-currency issuance, or tokenized contribution recognition, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 4—NFT certification: In a non-limiting profile for non-fungible token certification, content provenance, creator proof, or behavior-bound metadata certification, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 5—domain routing: In a non-limiting profile for domain-token routing, endpoint discovery, domain-context verification, or signed endpoint record validation, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 6—RWA observation: In a non-limiting profile for real-world-asset observation, site visit certification, physical inspection, or location-bound evidentiary capture, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 7—carbon credit attestation: In a non-limiting profile for carbon-credit attestation, environmental measurement, field observation, or sustainability credit verification, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 8—clearing precheck: In a non-limiting profile for clearing precheck, settlement eligibility, exchange listing, or compliance-gated transaction admission, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 9—rollback evidence: In a non-limiting profile for rollback evidence, challenge proof, dispute evidence, fraud response, or recertification record generation, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 10—AI-agent approval: In a non-limiting profile for AI-agent approval, delegated operation authorization, session-limited agent authority, or human-in-the-loop confirmation, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 11—health service proof: In a non-limiting profile for health service proof, care delivery record, clinical visit confirmation, or privacy-preserving medical participation proof, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 12—education credential proof: In a non-limiting profile for education credential proof, course completion attestation, training participation, or verified learning contribution, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 13—supply-chain custody: In a non-limiting profile for supply-chain custody, physical handoff, shipment inspection, or custody-chain proof, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 14—environmental monitoring: In a non-limiting profile for environmental monitoring, sensor-observed condition, site measurement, or recurring compliance observation, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Protocol profile 15—caregiving contribution: In a non-limiting profile for caregiving contribution, household support, social care, or time-based contribution proof, a verifier obtains a BEI Signature Artifact, payload hash or commitment, lifecycle endpoint, domain context, and verification-key identifier. The verifier evaluates identity-anchor reference, domain-hash consistency, validity-window status, anti-replay state, lifecycle status, privacy-proof validity, and audit-log commitment before allowing, denying, degrading, challenging, suspending, recertifying, revoking, or flagging the requested operation.

Field mappings for the foregoing profiles may map identity_anchor_ref to a person, device, organization, wallet, account, agent, or domain; domain_hash to a service endpoint or routing basepoint; behavior_category to an allowed event class; policy_version to a verifier rule set; evidence_commitment to a privacy-preserving proof reference; lifecycle_status to an active, challenged, suspended, recertified, or revoked state; and audit_commitment to a tamper-evident log entry.

Failure handling for the foregoing profiles may be normalized so that stale time, reused nonce, invalid proof, failed liveness, domain mismatch, canonical-encoding error, policy mismatch, suspended lifecycle state, revoked identity anchor, device mismatch, or missing audit commitment produces deterministic denial, challenge, suspension, recertification, or rollback-evidence output.

The foregoing profiles may be expressed in JSON, CBOR, ASN.1, protocol-buffer, smart-contract, API, DNS, DID, verifiable-credential, or equivalent machine-readable form, and may preserve only commitments or proof references where privacy rules require raw biometric, location, device, or behavioral data to remain local.

Interoperability adapters allow the BEI Protocol to transport or verify fields of a BEI Signature Artifact through external systems while preserving the artifact format, lifecycle semantics, anti-replay conditions, identity-anchor linkage, domain-context linkage, and audit-commitment requirements.

Adapter embodiment 1—DID document adapter: The BEI Protocol may employ a DID document adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 2—verifiable credential adapter: The BEI Protocol may employ a verifiable credential adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 3—passkey adapter: The BEI Protocol may employ a passkey adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 4—public-key certificate adapter: The BEI Protocol may employ a public-key certificate adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 5—DNSSEC/DANE adapter: The BEI Protocol may employ a DNSSEC/DANE adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 6—ISO 20022 adapter: The BEI Protocol may employ a ISO 20022 adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 7—smart-contract adapter: The BEI Protocol may employ a smart-contract adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 8—off-chain API adapter: The BEI Protocol may employ a off-chain API adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 9—hardware-security adapter: The BEI Protocol may employ a hardware-security adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 10—zero-knowledge verifier adapter: The BEI Protocol may employ a zero-knowledge verifier adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 11—selective-disclosure credential adapter: The BEI Protocol may employ a selective-disclosure credential adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

Adapter embodiment 12—audit-log adapter: The BEI Protocol may employ a audit-log adapter to expose, transport, resolve, or verify one or more fields of the BEI Signature Artifact, including a payload commitment, public-key identifier, domain hash, lifecycle status, policy version, privacy-proof reference, verifier decision, or audit-log commitment, without limiting the protocol to that external system.

A receiving system using any adapter may verify the artifact signature, payload commitment, identity-anchor reference, domain hash, policy version, validity window, anti-replay state, lifecycle status, and audit-log commitment before treating the artifact as sufficient authority for a downstream operation.

Claim support for modules: A claim element reciting a module, interface, engine, registry, state machine, endpoint, or processor is supported by the disclosed input-output relationships and state effects, including payload ingress, proof verification, canonical validation, anti-replay evaluation, signature generation, lifecycle lookup, verifier decisioning, and audit logging.

Claim support for data structures: A claim element reciting a payload, artifact, record, receipt, registry entry, endpoint record, policy version, proof reference, or audit commitment is supported by the canonical fields, deterministic encoding, hash commitments, lifecycle states, failure codes, and verifier outputs disclosed throughout the specification and drawings.

Claim support for single-actor paths: The server-side authority claim captures operation by a service that receives payloads or commitments and issues artifacts; the client method claim captures operation by a device that captures inputs and prepares proof material; and the verifier medium claim captures operation by an endpoint that gates downstream operations based on artifact validity.

Claim support for multi-entity deployments: A client, server, verifier, registry, and audit endpoint may be operated by different entities, yet each actor may still practice a complete claimed path through its own modules and instructions, thereby supporting deployment without requiring joint control by all ecosystem participants.

Claim support for technological neutrality: The invention remains useful if a particular blockchain, token standard, credential format, hash algorithm, signature algorithm, biometric sensor, domain registry, wallet provider, messaging rail, or external compliance standard changes because the durable core is the ordered combination of behavior-bound evidence, privacy proof, canonical payload, identity anchor, domain context, anti-replay state, lifecycle registry, verifier-gated authority, and audit commitment.

### FORMAL TECHNICAL CLOSURE

The disclosure is intended to make the BEI Signature Artifact a technical prerequisite for downstream authority rather than a decorative metadata field. A downstream system that recognizes behavior-derived value, identity authority, token issuance, NFT certification, wallet authority, RWA observation, access rights, or clearing entry can require the artifact before the downstream operation is accepted.

The term civilizational economy, when used, refers to technical infrastructure that can operate across large populations, industries, and time scales by converting behavior evidence into verifiable, privacy-preserving, lifecycle-controlled digital authority. The claims do not require political, social, or economic theory; they require machine-readable payloads, proofs, state transitions, registries, artifacts, and verifier decisions.

Each independent claim captures a different single-actor path. The server-side authority claim captures operation by a service that receives payloads or commitments and issues artifacts. The client method claim captures operation by a device or wallet that captures inputs and constructs payloads. The verifier medium claim captures operation by a downstream endpoint that validates artifacts and gates operations. These paths can be licensed independently or combined into an integrated stack.

The invention remains useful if a particular blockchain, token standard, hash algorithm, signature algorithm, wallet provider, biometric sensor, domain registry, or compliance rail changes. The durable technical core is the ordered combination of canonical payload construction, privacy-preserving proof verification, anti-replay state, identity-and-domain binding, lifecycle registry, signature artifact generation, verifier-gated operation, and tamper-evident audit commitment.

1. A server-side behavior-bound cryptographic signature authority system comprising: a payload-ingress interface configured to receive, from a client device or authorized source, a canonical behavioral payload or commitments thereto, the canonical behavioral payload including at least an identity-anchor reference, domain-context data, temporal marker data, device-context data, behavioral-context data, and a nonce or uniqueness value; a privacy-proof verifier configured to verify a liveness, proximity, biometric-consistency, location-consistency, device-consistency, or behavior-presence proof without requiring disclosure of raw biometric data to the server-side authority; a canonical-payload validator configured to validate a deterministic field order, encoding rule, domain hash, validity window, and payload commitment for the canonical behavioral payload; an anti-replay state machine configured to reject a signature request when the nonce or uniqueness value has been consumed, when a time window is stale, when a device or domain consistency rule fails, or when a prior signature state conflicts with the signature request; an identity-and-domain binding module configured to bind the identity-anchor reference to the domain hash and to a lifecycle status record; a cryptographic signature engine configured to generate a BEI Signature Artifact only after the privacy-proof verifier, the canonical-payload validator, the anti-replay state machine, and the identity-and-domain binding module each return an accept state; a lifecycle registry configured to record at least issued, bound, expired, challenged, suspended, recertified, and revoked lifecycle states of the BEI Signature Artifact; and a tamper-evident audit-log interface configured to store or publish a commitment of the BEI Signature Artifact and a state-transition receipt, wherein a verifier is enabled to determine, without receiving raw biometric data, whether the BEI Signature Artifact is eligible for token issuance, minting eligibility, wallet authorization, NFT certification, domain-token routing, access control, clearing compliance, or rollback evidence.

2. The system of claim 1, wherein the privacy-proof verifier verifies a zero-knowledge proof, zk-SNARK, zk-STARK, selective-disclosure credential, verifiable credential presentation, trusted-execution-environment attestation, threshold attestation, or equivalent privacy-preserving compliance proof.

3. The system of claim 1, wherein the canonical behavioral payload includes one or more of a biometric commitment, a geolocation commitment, a timestamp, a device fingerprint salt, a domain basepoint, a domain hash, a behavior category, a wallet identifier, a public-key identifier, a policy-version identifier, and an expiration parameter.

4. The system of claim 1, wherein the anti-replay state machine maintains a consumed-nonce set, a counter, a prior-signature hash, a validity-window register, a device-consistency register, and a domain-consistency register.

5. The system of claim 1, wherein the cryptographic signature engine uses an algorithm selected from ECDSA, EdDSA, threshold signature, hardware-secured signing, post-quantum signature, or an equivalent public-key signing algorithm, and applies SHA-256, SHA-3, BLAKE2, BLAKE3, or an equivalent cryptographic hash function.

6. The system of claim 1, wherein the liveness or behavior-presence proof includes an unpredictable real-time interaction, a challenge-response gesture, a voice challenge, a facial-motion challenge, a gait or device-motion response, a sensor-fusion response, or a deepfake-detection confidence value.

7. The system of claim 1, wherein the lifecycle registry triggers recertification or suspension when expiration, geographic mismatch, device mismatch, biometric mismatch, domain mismatch, policy challenge, fraud signal, artificial-intelligence-generated impersonation signal, or user-requested renewal is detected.

8. The system of claim 1, wherein the tamper-evident audit-log interface writes the state-transition receipt to an append-only log, Merkle tree, distributed ledger, permissioned ledger, WORM storage, or equivalent integrity-preserving data structure.

9. A client-device method for obtaining a behavior-bound cryptographic signature, comprising: capturing, at a client device, multimodal input data comprising biometric input data, geolocation input data, temporal marker data, device-context data, domain-context data, and behavioral-context data; executing a local liveness and quality gate that produces an accept, reject, degrade, or challenge gate result; constructing a canonical behavioral payload using a deterministic encoding order and including at least an identity-anchor reference, a domain hash, a nonce, a validity window, a payload commitment, and an expiration parameter; generating a privacy-preserving proof or commitment package that proves behavior presence or input consistency without transmitting raw biometric data when privacy settings require local retention; transmitting the canonical behavioral payload or commitments thereto to a signature authority; receiving, from the signature authority, a BEI Signature Artifact or a rejection code; and binding the BEI Signature Artifact to a wallet credential, token metadata record, minting request, access credential, non-fungible token certification record, domain-token record, or clearing-eligibility request.

10. The method of claim 9, wherein the multimodal input data includes one or more of facial imagery, voice samples, fingerprint data, gait tracking, device inertial measurements, near-field communication data, Bluetooth distance-bounding data, time-of-flight measurements, Wi-Fi positioning data, cellular-triangulation data, or proximity-beacon data.

11. The method of claim 9, wherein the local liveness and quality gate generates a failure code selected from insufficient liveness, stale timestamp, geolocation mismatch, device mismatch, domain mismatch, reused nonce, sensor spoofing, deepfake confidence above threshold, or biometric confidence below threshold.

12. The method of claim 9, wherein the deterministic encoding order defines a canonical byte sequence for the identity-anchor reference, domain hash, device salt, timestamp, geolocation commitment, behavior category, nonce, validity window, and payload commitment.

13. The method of claim 9, wherein the privacy-preserving proof is generated by proving, in zero knowledge or selective disclosure, that a location is within an authorized region, that a liveness score exceeds a threshold, that a device salt corresponds to an enrolled device, or that a behavior event occurred within the validity window.

14. The method of claim 9, further comprising using the BEI Signature Artifact as a precondition for BEIMINT issuance, BEINFT certification, BEIWALLET high-risk authorization, BEISIGN transaction entry, BEIProof verification, domain-token minting, real-world-asset observation certification, carbon-credit site attestation, or time-currency eligibility.

15. The method of claim 9, wherein binding the BEI Signature Artifact to a record comprises storing a signature value, a payload hash, a public-key identifier, a lifecycle-status pointer, an audit-log commitment, and a verifier-registry endpoint in metadata of the record.

16. A non-transitory computer-readable medium storing instructions that, when executed by one or more processors of a verifier, minting, wallet, access-control, NFT, domain-token, or clearing endpoint, cause the one or more processors to: receive a BEI Signature Artifact and a canonical behavioral payload or commitment thereto; verify a public-key signature over a payload hash;
retrieve a lifecycle status record from a verifier registry or lifecycle registry; validate a domain hash, identity-anchor reference, validity window, nonce status, and audit-log commitment associated with the BEI Signature Artifact; deny an operation when the lifecycle status is expired, challenged, suspended, revoked, inconsistent, or not found; and allow or conditionally allow the operation only when the BEI Signature Artifact is valid and its lifecycle status satisfies an operation-specific policy.

17. The non-transitory computer-readable medium of claim 16, wherein the operation comprises minting a behavior-based value unit, issuing a time-currency unit, certifying an NFT, authorizing a wallet transaction, verifying a domain-token route, allowing access to a protected resource, or entering a policy-controlled transaction rail.

18. The non-transitory computer-readable medium of claim 16, wherein the instructions further cause the one or more processors to request recertification, challenge-response, step-up authentication, suspension, or rollback evidence when the validity window, domain hash, device-context data, behavior-context data, or audit-log commitment fails validation.

19. The non-transitory computer-readable medium of claim 16, wherein the verifier validates a real-world-asset observation by determining that a human observer, device, or authorized source produced a BEI Signature Artifact at a physical location and time window associated with a tokenized asset, carbon-credit measurement, site audit, inspection, delivery event, health event, education event, or civilizational-economy contribution event.

20. The non-transitory computer-readable medium of claim 16, wherein the BEI Signature Artifact is chain-neutral and messaging-rail neutral and is verified across a smart-contract verifier, off-chain verifier, standards-gateway verifier, or external validator while preserving privacy by using commitments or privacy-preserving proofs instead of raw biometric data.
